(19) United States
(12) Patent Application Publication
(10) Pub. No.: US 2026/0132715 A1
(43) Pub. Date: May 14, 2026

(54) METHOD AND MATERIAL REMOVAL SYSTEM

(71) Applicant: ROCKFEEL GMBH, Freiberg (DE)

(72) Inventors: Joerg BRETSCHNEIDER, Dittmannsdorf (DE); Taras Shepel, Freiberg (DE); Serdar Yasar, Freiberg (DE)

(21) Appl. No.: 18/868,576

(22) PCT Filed: Jun. 5, 2023
(86) PCT No.: PCT/EP2023/064950

§ 371 Date: Nov. 22, 2024

(30) Foreign Application Priority Data
Jun. 14, 2022 (DE) 10 2022 114 940.4

(51) Int. Cl. E21C 35/00; E21C 27/24; E21D 9/10; G06T 7/00; G06T 7/62; G06T 7/66; H04N 13/204; H04N 23/23

(52) U.S. Cl. CPC E21C 35/302; E21C 27/24; E21D 9/1026; G06T 7/0002; G06T 7/62; G06T 7/66; H04N 23/23; G06T 2207/10012; G06T 2207/10048; G06T 2207/30204; H04N 13/204

(57) ABSTRACT

According to various embodiments, an excavation system may include an excavation machine having a machine pick and configured to excavate a material using the machine pick, an infrared camera for sensing temperature-based image data representing a machine pick, and a data processing device configured to determine an indication representing at least one geometrical property of the machine pick based on the temperature-based image data and determine a state of the machine pick based on the indication.

### CROSS-REFERENCE TO RELATED APPLICATIONS

The present application is a national stage entry according to 35 U.S.C. § 371 of PCT application No.: PCT/EP 2023/064950 filed on Jun. 5, 2023; which claims priority to German Patent Application Serial No.: 10 2022 114 940.4, which was filed on Jun. 14, 2022; which are incorporated herein by reference in their entirety and for all purposes.

### TECHNICAL FIELD

Various embodiments relate to a method and an excavation system.

### BACKGROUND

In mining, tunnelling, or underground construction, mechanical rock cutting machines such as roadheaders, continuous miners, surface miners, and tunnel boring machines are used to a certain extent to excavate the rock or a valuable mineral along with the surrounding rock. This so-called mechanical cutting is already established in coal mining, salt mining and the cutting of soft minerals such as clay, gypsum or limestone, but is also increasingly being used for gangue minerals. In tunnelling and underground construction, profiles, shafts and trenches are created using special rock cutting machines.

Tool wear is a major challenge in this context and therefore requires a great amount of effort. The monitoring of wear and the endeavour to change worn cutting tools at an optimum time with regard to high cutting performance and the use or number of working tools required for this need a considerable amount of work and time, which in practice is often carried out manually, i. e. without any type of automation.

Mechanical excavation or cutting using rock cutting machines is primarily carried out with rotatable machine picks mounted on rotating cutting heads (also referred to simply as picks in the following), wherein a distinction is made between two basic types.

Particularly in the coal industry, mining is also carried out with fixed picks (so-called radial picks) on so-called shearer machines or shearer loaders. Wear is caused by continuous abrasion of the machine pick while working the rock or by parts breaking off or even breaking off of the pick head or the edge of the pick due to excessive load during cutting. Friction causes the pick to heat up to a normal operating temperature, which may be more than 100° C., or even up to 400° C. at the tip or edge. However, excessive load may cause this thermal heating to reach the melting point of the material relatively quickly. Avoiding this is therefore a key objective in operational management and has so far required experienced operating personnel in particular.

Tool wear is usually taken care of by an inspection cycle based on local conditions and the experience of the machine operator, typically involving a detailed visual inspection of each individual pick. This involves stopping the machine, cleaning it roughly in some cases and, if necessary, bringing in lighting so that each individual pick may be inspected from all sides. To do this, the picks are rotated by hand in the holders and, if necessary, loosened with a hammer if material has become jammed in the holders (also referred to as pick blockage) and is preventing the wear-distributing rotation of the pick.

When cutting in very hard rock, it may be necessary to carry out the inspection cycle on an hourly basis. Even in anhydrite-rich rock salt, this inspection is carried out up to four times per shift, i. e. every two hours. Frequent inspections mean a considerable loss of working time, which reduces utilization of expensive machines and thus increases production costs. Conventional concepts for automating inspection are based on measurements on the power train, on acoustic emission measurements or measurements on the pick itself, for example by measuring the pick profile with an optical camera or laser, or by non-contact temperature measurements on the pick tips. These concepts may provide sufficient results under favourable operating conditions, for example in road construction and open pit mining, but are considerably affected by difficult operating conditions, such as those typically encountered in tunnelling or underground mining.

Measurements on the power train do not allow any conclusions to be drawn as to which particular pick is worn and to what extent or in what way. Increased power consumption of the power train may only indicate a significant number of heavily worn picks, as the power consumption of the power train is averaged over all machine picks.

Measurements on the pick itself, for example of its temperature, are often subject to a variety of influencing variables, such as rock hardness and thrust forces, of which wear state of the pick (also referred to as pick wear state) is only one influencing variable and is therefore difficult to distinguish from other influencing variables as a cause. While the total loss of a single pick during operation may not be noticed even by experienced personnel, it immediately causes serious damage to the pick holder, which may lead to machine failure. Inspection according to a fixed cycle is therefore often not sufficient to prevent the damage to the machine occurring in the event of unfavourable wear. Measurements of acoustic emissions are problematic with respect to the fact that there are many sources of noise when operating a rock cutting machine on the one hand, but also that due to the limited space and sometimes rough walls underground, a variety of overlays may arise, which greatly hinder analysis and clear classification. Changing cutting parameters of the operator or varying rock conditions also change these noises considerably. It is therefore difficult to determine which pick is causing them.

### SUMMARY

According to various embodiments, it was clearly recognized that conventional imaging measurement relies on good visibility and lighting conditions, e. g. using external lighting, which is why this is very sensitive to dust formation, dust deposition, water mist and water accumulation, which considerably limits possible application, for example in the absence of light, and especially underground. For example, external lighting is ineffective when there is a lot of dust and water mist. Furthermore, the tip or edge of the pick may often be virtually indistinguishable from the background of the image due to the dust formation, dust deposits and/or the similar colouring of rock, dust and the machine pick (also referred to in simplified terms as pick).

In this context, it was recognized that infrared radiation is less subject to these limitations than visible light. It was clearly recognized that machine picks become hot during regular operation and thus themselves become a source of infrared radiation without the need for external lighting, and that this infrared radiation emitted by the pick penetrates dust better and is subject to fewer distorting influences than visible light. This infrared radiation emitted by a heated pick is therefore easier to distinguish from the (comparatively cold) image background in the infrared image (also referred to colloquially as thermal image) than the reflections of visible light in conventional imaging methods. It was also recognized that conventional infrared measurement methods primarily focus on exceeding absolute temperature thresholds. However, measured values of absolute temperature are comparatively sensitive to disturbances typical for construction (esp. mining) caused by dust and water, which is why such methods have not yet been developed for practical use.

According to various embodiments, the spatial geometry (e. g. the profile) of a machine pick (also referred to herein as pick geometry in short) is determined using the present invention, e. g. the geometry of the parts influencing its cutting performance, based on the infrared radiation emanating from (i. e. emitted by) it (also referred to colloquially as thermal radiation). Based on the determined pick geometry, the state of the machine pick, e. g. its wear state, and/or is in turn determined in comparison to a defined reference state (also referred to as reference state). This determination of the pick geometry on the basis of infrared radiation is to be distinguished from a sole measurement the temperature of the machine pick (also referred to as pick temperature), even if this pick temperature is determined using an infrared camera (also referred to colloquially as thermal camera). This is because, in contrast to the pick temperature, the pick geometry is solely dependent on the wear state of the machine pick and is therefore subject to fewer influencing variables than the pick temperature. This also applies in the case of temporary adhesion of material, as this is released again within a short time due to the rock contact and therefore a clear measurement result may be generated, e. g. by simple statistical averaging over several revolutions of the cutting head.

Thus, determination of the pick geometry enables a more reliable determination of the state of the machine pick than if, for example, the temperature of the machine pick is taken as a basis.

The mechanical interaction, which occurs at the contact points of the machine pick with the rock during the excavation process, excavates the rock on the one hand and releases heat energy on the other hand, so that the pick temperature rises during the excavation process until a balance is reached between frictional heat input during the actual cutting and heat radiation during the idle revolution of the pick, and the machine pick itself is worn (also referred to as pick wear). Pick wear is a consequence of the fact that the pick is also subjected to mechanical stress at its contact points with the rock during the excavation process and is thus used up, eroded, deformed and/or broken (also referred to as pick breakage). This pick wear changes the pick geometry (e. g. the pick contour) and may increase the contact surface between machine pick and rock, so that pick temperature may continue to rise as the pick wears. Temperature of the pick tip or pick edge may reach over 1000° C. and even lead to softening or melting of parts of the pick tip or pick edge. This in turn accelerates pick wear, so that pick wear is not necessarily linear in time, but is accelerated, for example exponentially, over time.

While this is counteracted in part by the less deep penetration of a heavily worn machine pick into the rock than that of a neighbouring and less worn machine pick, this only shifts cutting forces to less heavily worn machine picks, so that these in turn wear more quickly, compared to, for example, if all machine picks would be worn evenly. In addition, when machine picks are worn differently, fluctuating cutting forces may cause the cutting head to vibrate, which significantly reduces cutting performance. For the same reason, an imbalance may occur in the load distribution, which leads to faster wear of new machine picks in conjunction with excessive vibrations on the cutting head. In the event of an undetected pick breakage, there is also a risk of the valuable pick holder coming into contact with the rock and being damaged.

Therefore, in regular process, conical picks are mounted rotatably so that the arising friction surface is not enlarged, but is twisted by arising lateral forces on the pick. In this way, the pick tip of conical picks is eroded more evenly until the pick head with the carbide tip is largely ground to a round shape. This so-called symmetrical wear state may be detected by visual inspection during regular inspections, so that the respective pick is replaced on a regular basis. However, the unavoidable ingress of dust into the pick holders regularly causes the pick to become stuck. A conical pick may then no longer rotate, resulting in a very rapidly growing, larger friction surface. The force required to push the pick just as deeply into the rock as if it was only slightly or regularly worn increases in proportion to that surface's size. This so-called asymmetric wear then leads to overheating, melting, partial or complete breakage of the pick head and the serious consequential damage described above in a very short time, considerably shorter than any control cycle.

Therefore, access to pick wear and its monitoring are of great importance for efficient, especially cost-efficient, rock cutting. This would facilitate the timely detection of significantly worn machine picks that, for example, need to be replaced or are otherwise no longer functional, thus saving costs that may otherwise occur due to damage to other picks, pick holders, repair times and reduced cutting performance. This may, for example, prevent not only the pick from becoming worn, but also the pick holder from being damaged up to the point of total erosion, which would result in considerable repair times and therefore downtimes.

This and the circumstances described above are taken into account according to various embodiments. The method, computer implementations thereof, and excavation system provided according to various embodiments simplify state monitoring (e. g. wear monitoring) of machine picks. This includes the early detection of progressive wear on the picks, but also the timely detection of individual broken or otherwise severely worn-out picks, even outside of fixed inspection intervals, so that the operating time of the machine and its power consumption lead to optimum cutting performance. In particular, severe wear may be prevented, which, for example, may lead to extreme wear and overloading of the pick within a few minutes due to the breakage of a pick tip, including breakage and erosion of the valuable pick holder welded onto the cutting drum, as well as overloading and severe wear of other picks. Since such and similar accidents may result in very long repairs and, due to the missing excavation quantities, very costly downtimes of the expensive machines, which are usually only available in small quantities in a mine, costs may also be avoided. Downtime costs of ten thousand Euros per hour or more are realistic in certain operations.

The failure of picks in so-called tunnel boring machines (TBMs) is similarly serious. Here, an inspection involves not only a brief stop, but also moving back the entire machine, which weighs hundreds of tons and is braced in the tunnel, in order to access the excavation site from inside the machine and examine the picks.

The method provided according to various embodiments of the present invention and a correspondingly equipped excavation system facilitate state monitoring (e. g. wear monitoring) of machine picks, in particular under conditions of severely restricted visibility, release of dust and water mist and possibly also in the event of temporary sinking into the excavated loose material or in the event of considerable soiling of the working tools.

The embodiments described herein are applicable to excavation machines (e. g. rock cutting machines) of any type, in particular those in which rotating cutting drums with conical picks are mounted. Examples of such excavation machines comprise so-called roadheaders, continuous miners, shearer loaders, horizontal cutters, surface miners and drum cutters. Excavation machines of these types are used in mining of coal, salt, silicates or ores, in underground and surface mining, in tunnel construction, road and hydraulic engineering, in quarries and in the demolition of buildings.

The embodiments described herein generate considerable economic advantages over conventional concepts in a mine where mechanical cutting is used. These arise from the considerably higher potential utilization of the highly complex cutting machines, because the invention significantly reduces the number of regular, periodic cutting head inspections and accidents after a pick breakage are almost completely avoidable, as well as from the increase in operational safety, since personal inspections at the cutting head, directly at the excavation face, are required less frequently. If widely used, the embodiments described herein generate considerable economic benefits in the form of increased efficiency of rock excavation processes in mining and underground construction, combined with lower producer prices for the raw materials extracted for industry and lower construction costs for underground structures. The embodiments described herein thus also promote the expansion of the use of the rock and resource-efficient technology of mechanical cutting in place of drilling and blasting with subsequent crushing and processing. This in turn has the potential to have a considerable positive effect on the economic feasibility, the ecological footprint and ultimately also the acceptance of the indispensable mining of the various basic materials of industrial society among the population. The present invention thus also represents a contribution to the long-term securing of resources.

One basic type, known from but not limited to the so-called full-face cutting machines or tunnel boring machines (TBMs), uses so-called roller cutters (e. g. disk cutters), which are disposed on a cutting head rotating in the direction of advance at various distances from the centre and are pressed against the rock by rolling on the rotating, hardened cutting edge. The other basic type uses so-called conical picks on cutting heads that preferably rotate vertically, but sometimes also in the direction of advance, which are pressed against the rock by friction with the hardened tip. However, the conical picks themselves may and should rotate around their axis of attack in order to ensure even wear and thus increase service life.

### BRIEF DESCRIPTION OF THE DRAWINGS

In the Drawings:

FIG. 1 shows a process according to various embodiments in a schematic flow chart;

FIGS. 2, 3 and 4 each show an excavation system according to various embodiments in different representations;

FIGS. 5A and 5B each show an excavation system according to different embodiments in a schematic perspective view;

FIGS. 6A and 6B each show an excavation system according to different embodiments in a schematic perspective view;

FIG. 7 is a schematic perspective view of an excavation system according to various embodiments;

FIGS. 8, 9, 10 and 11 show different components of the method according to different embodiments in a diagram;

FIGS. 12 and 19 each show a configuration of the camera system during image sensing according to various embodiments in a schematic perspective view;

FIGS. 13, 14, 15 and 16 each show a schematic side view of a machine pick according to various embodiments;

FIGS. 17A and 17B and 20A and 20B each show machine picks of different states in a schematic perspective view and resulting geometrical representations in a schematic view according to different embodiments; and

FIG. 18 is a graphical user interface of the excavation machine in a schematic top view.

### DETAILED DESCRIPTION

In the following detailed description, reference is made to the accompanying drawings which form part thereof and in which specific embodiments are shown for illustrative purposes in which the invention may be practiced. In this regard, directional terminology such as “top”, “down”, “forward”, “rearward”, “front”, “rear”, etc. is used with reference to the orientation of the figure(s) being described. Since components of embodiments may be positioned in a number of different orientations, the directional terminology is for illustrative purposes and is not limiting in any way. It is to be understood that other embodiments may be used and structural or logical changes may be made without departing from the scope of protection of the present invention. It is to be understood that the features of the various exemplary embodiments described herein may be combined with each other, unless specifically stated otherwise. The following detailed description is therefore not to be understood in a limiting sense. The scope of protection of the present invention is defined by the appended claims.

In the context of this description, the terms “connected”, “attached” and “coupled” are used to describe both a direct (e. g. form-fit or materially bonded) and an indirect connection (e. g. via a signal path), a direct or indirect attachment and a direct or indirect coupling. In the figures, identical or similar elements are provided with identical reference symbols as far as this is appropriate.

Actual state of an entity (e. g. a device, an item, a system or a procedure or process) may be understood as the state of the entity that is actually present or may be detected by sensors. The target state of the entity may be understood as the desired state, i. e. a specification, which may optionally be stored, for example in a data memory. Control may be understood as an intended influence on the current state (also referred to as actual state) of the entity. The current state may be changed in accordance with the specification (also referred to as target state), e. g. by changing one or more operating parameters (then also referred to as manipulated variable) of the entity, e. g. using an actuator. Closed-loop control may be understood as control, wherein in addition a state change of the entity due to malfunctions is counteracted. For this purpose, the actual state is compared with the target state and the entity is influenced, e. g. using an actuator, in such a way that the deviation of the actual state from the target state is minimized. Closed-loop control, in contrast to a solely forward oriented sequence controller, has a progressive influence of the output variable on the input variable, which is effectuated by the control loop (also referred to as feedback). In other words, it may be herein understood that closed-loop control may be used alternatively or additionally to open-loop control (or to actuation) or a closed-loop control may take place alternatively or additionally to open-loop control.

The term “data processing device” may be understood as any type of logic-implementing entity that may comprise, for example, circuitry and/or a processor that may execute software stored in a storage medium, firmware, or a combination thereof, and output instructions based thereon. The data processing device may, for example, be set up using code segments (e. g. software) to control the operation of a system (e. g. its operating point), e. g. a machine or a plant, e. g. its components.

The term “processor” may be understood as any type of entity that allows the processing of data or signals. For example, the data or signals may be handled according to at least one (i. e., one or more than one) specific function performed by the processor. A processor may comprise or be formed from an analogue circuit, a digital circuit, a mixed signal circuit, a logic circuit, a microprocessor, a central processing unit (CPU), a graphics processing unit (GPU), a digital signal processor (DSP), a field programmable gate array (FPGA), an integrated circuit (IC), or any combination thereof. Any other type of implementation of the respective functions described in more detail below may also be understood as a processor or logic circuit. It is understood that one or more of the method steps described in detail herein may be performed (e. g., realized) by a processor, through one or more specific functions performed by the processor. The processor may therefore be configured to perform one of the methods or its information processing components described herein.

According to various embodiments, a data memory (more generally also referred to as a storage medium) may be a non-volatile data memory. For example, the data memory may comprise or be formed from a hard disk and/or at least one semiconductor memory (such as read-only memory, random access memory and/or flash memory). The read-only memory may, for example, be an erasable programmable read-only memory (may also be referred to as an EPROM). The random-access memory may be a non-volatile random-access memory (may also be referred to as NVRAM). For example, in the data storage one or more of the following may be stored: a database (may also be referred to as a reference database); a processing algorithm; a criterion; code segments implementing, for example, one or more processing algorithms (simplified also referred to as an algorithm). The database may comprise one or more data sets, each data set associating a product identifier with payment information and/or a sales restriction. This may be read by the data processing device.

Various embodiments relate to a machine pick (also referred to herein simply as a pick) and its state. The term “machine pick”, as used herein, may be understood as a machine tool which may comprise components (e. g. rigidly) connected to each other (e. g. in a materially bonding, force-fitting and/or form-fitting manner). Examples of a machine pick comprise: a roller cutter (e. g. a disk cutter or a button cutter), a conical pick (e. g. of a road construction machine, of a roadheader or of a surface miner), a radial pick (e. g. of a shearer-loader), an excavation tooth (e. g. of an excavator, e. g. of a bucket wheel excavator), a roller cutter, e. g. of the disk cutter type (e. g. but not limited to a tunnel boring machine, a mobile miner). Two or more of the components of the machine pick may optionally be part of a monolithic body, e. g. made from one piece. Examples of the components of the machine pick comprise: an assembly component and a cutting component.

In the case of a conical pick or radial pick, the assembly component may be shaft-shaped (then also referred to as the pick shaft, for shorter shaft) and the cutting component may be head-shaped (then also referred to as the pick head). The pick head and/or the pick shaft may, for example, be bodies of rotation. The conical pick or radial pick may be extended longitudinally (e. g. from its rear side to its front side) along a longitudinal axis (also referred to as the pick axis). The conical pick or radial pick may comprise the pick tip (illustratively on the front side), through which, for example, the pick axis may run. In the case of a roller cutter (e. g. disk cutter), the assembly component may comprise a bearing (or at least be configured to receive a bearing) and the cutting component may be ring-shaped (then also referred to as a roller base body).

The cutting component (e. g. the pick head) comprises a cutting edge, e. g. a cutting corner or cutting tip (also referred to as a pick tip) (for example on the front of the machine pick). In the case of a roller cutter (e. g. disk cutter), the cutting edge may be ring-shaped (also referred to as a cutting ring). The cutting component of the roller cutter (e. g. disk cutter) may comprise one or more cutting rings.

The pick tip (e. g. of a conical pick), for example, forms the front edge of the pick and may comprise a tapered (e. g. conical) shape towards the front. The pick head may be connected to the shank (which extends towards the rear) on the side opposite the pick tip or the side facing the rear of the machine pick, e. g. with a material connection. The pick head may optionally comprise a thickening that protrudes from the pick tip and/or the pick shaft.

Optionally, the cutting component (e. g. the pick head) may consist of several materials, one of which (also referred to as the cutting-edge material) provides the cutting edge. In the case of a conical pick, the cutting-edge material may be pin-shaped (then also referred to as a pick pin). The cutting-edge material preferably comprises a greater hardness than the rest of the cutting component (e. g. the pick head) and/or than the mounting component (e. g. the pick shaft). The pick pin may, for example, be embedded in the rest of the pick head, e. g. pressed in. The pick pin may be tapered, parabolic or stepped. The pick pin may, for example, be ceramic or comprise at least one ceramic (e. g. a carbide, such as tungsten carbide, and/or nitride) or be produced therefrom. The pick head and/or the pick shaft may be metallic or comprise at least one metal, e. g. steel, or be produced therefrom.

In another embodiment, for example a so-called roller cutter (e. g. disk cutter), the cutter extends concentrically from its cutter axis (in this case also referred to as the central axis), around which the cutter may be rotatably mounted, for example, and comprise a cutter edge made of hardened material.

Herein reference is made to image data and its processing. The image data may be a digital (e. g., data-based) image of reality (e. g., within a field of view) at one or more points in time of capturing the image data (also referred to as image sensing). For example, the imaging of reality may take place using a lens (also referred to as a camera lens) that projects electromagnetic radiation (e. g., visible or infrared light) onto the surface of an image sensing sensor (e. g., an infrared sensor of an infrared camera). Sensing the image data may comprise reading out the image sensing sensor while the radiation (e. g. infrared radiation) is projected onto its surface. The image data obtained in this way may initially be in the so-called raw data format (also referred to as RAW), which comprises the read-out measured values (e. g. representing an intensity of the light) of the image sensing sensor pixel by pixel and/or is processed as such. The image data may optionally be or be converted into another image format during processing, e. g. into a raster graphic (different from RAW as a raster graphic) or a vector graphic, so that their further processing is carried out in this image format, or may be converted between these as desired. Converting may optionally comprise interpolating the measurement values of the image sensing sensor (e. g. using demosaicing), e. g. to obtain complete multicolour information for each pixel or to require less memory or computing power. The image data may optionally be compressed (e. g. to require less storage space or computing power) or uncompressed (e. g. to avoid distortions). The respective image format may also define the colour space according to which the colour information is specified.

The simplest case is the monochrome colour space, which may be a binary colour space, for example, in which one black and white value is stored per pixel. In a somewhat more complex monochrome colour space (also known as grayscale colour space), intermediate levels between black and white are also stored (also known as grey values). In a monochrome colour space, the recorded radiation energy (e. g. from infrared radiation) is added up pixel by pixel and mapped to a grey value of the monochrome colour space, which represents the intensity of the recorded radiation at the wavelength or wavelength range (e. g. infrared range) at which the monochrome image sensing sensor is sensitive. However, the colour space may also be spanned by several (i. e. two or more) reference colours, such as red, green and blue. If a wavelength-sensitive image sensing sensor (also known as a polychrome image sensing sensor) is used, the measured values per pixel may show the radiant energy and additionally a wavelength assigned to the radiant energy. This would improve accuracy of an optional temperature measurement based on the image data. Such measured values may be displayed using a multicoloured colour space or may also be converted into a monochrome colour space. In a similar way, a value from a monochrome colour space may also be converted into a polychrome colour space, for example in the case of so-called false colour representation.

For visual reproduction of the image data on a display device, it is converted into the image format, that is specified by the image memory of the graphics card. The image data described herein is presented as such a visual reproduction for easier understanding. In general, the image data, e. g. stored in a storage medium, may be available as a file (also referred to as a digital image or image file) in the respective image format.

The image data may comprise one or more frames (e. g., from different perspectives) as a digital (e. g., data-based) image of reality (e. g., within a field of view), each frame corresponding to a time of sensing. For example, the image data may comprise, for each time of sensing, one or more frames which are the image of reality at that time (also referred to as image sensing time). For example, the image data may comprise one frame or several frames (e. g. from different perspectives) for each point in time of a sequence of several points in time, for example in the form of a video. Several frames (e. g. from different perspectives or from different points in time) may alternatively or additionally be combined to form a new frame, for example along a time axis and/or a spatial axis. For example, several frames that are sensed during the revolution of a cutting head and of which each frame represents only a part of the cutting head may be combined to form a new frame that is assigned any point in time from the duration of the revolution.

A camera may be understood as an optical device comprising the camera lens and the image sensing sensor, which interact in such a way that light from the field of view of the camera (also referred to as the image sensing area) is projected onto the surface of the image sensing sensor using the camera lens. Furthermore, the camera may comprise a processor that is configured to provide the measured values read out by the image sensing sensor as image data, e. g. to output them.

An image sensing sensor (also referred to as an image sensor) is of the optoelectronic sensor type and may comprise one or more photoelectrically active areas (may also be referred to as pixels) which generate and/or modify an electrical signal, e. g. in response to electromagnetic radiation (e. g. infrared light). For example, the image sensing sensor may comprise a number B of 10² pixels (also referred to as image resolution) or more, e. g. 10³ pixels or more, e. g. 10⁴ pixels or more, e. g. 10⁵ pixels or more. The image sensing sensor may alternatively or additionally comprise a raster R of [k×l] pixels (e. g. with B=k·l), where k and/or l are greater than about 50, than about 100 or than about 1000. In general, however, the image resolution may also be greater than B.

In some embodiments, the infrared camera (also referred to as a thermal camera) and/or the image sensing sensor are configured (e. g., disposed and/or oriented) in such a way that the portion of the image sensing sensor sensing the machine pick comprises the number B and/or the raster R of pixels. If the portion is smaller, frames from several infrared cameras and/or image sensing sensors may be superimposed on one another in order to increase the resolution and/or the raster per machine pick. Alternatively, or additionally, a camera lens with a larger focal length may be used.

The image sensing sensor may, for example, comprise or be formed from a CCD sensor (charge-coupled device sensor) and/or an active pixel sensor (may also be referred to as a CMOS sensor). Optionally, an image sensing sensor may be configured as wavelength-sensitive (e. g. for detecting colour information), e. g. using several colour filters (e. g. in grid form), and thus distinguish between different wavelengths.

An infrared camera may be understood as a camera which (e. g. whose image sensing sensor) is configured sensitive (e. g. only) to infrared radiation (colloquially also referred to as thermal radiation) and does not necessarily have to be wavelength sensitive (i. e. may be a monochrome camera). For example, the infrared camera may comprise a greater sensitivity (i.e. sensitivness) for infrared radiation (e. g. in the range of about 3.5 μm to about 15 μm) than for visible light (or at least for radiation with a wavelength of less than 0.78 μm).

The infrared radiation to which the infrared camera is sensitive may comprise light having a wavelength in a range from about 0.78 μm (micrometres) to about 1000 μm, e. g., mid-infrared (e. g., 3 μm to 50 μm) and optionally near infrared (e. g., 0.78 μm to 3 μm) and/or far infrared (e. g., 50 μm to 1000 μm). The infrared radiation to which the infrared camera is sensitive may, for example, be light with a wavelength in a range of approximately 3.5 μm to approximately 15 μm, which best corresponds to the expected temperatures of the machine pick.

In general, a body may emit infrared radiation, as an alternative or in addition to visible light, for example from its surface. According to Planck's law of radiation, the emitted infrared radiation (e. g. the distribution of electromagnetic radiation power as a function of wavelength) depends on the temperature of the body. The read-out measured values of the image sensing sensor of the infrared camera (e. g. representing the intensity of the infrared radiation recorded pixel by pixel) are thus a function of a spatial temperature distribution, in particular a spatial distribution of infrared radiation, which in turn is a function, but not exclusively, of the temperature of the surface emitting infrared radiation, in the field of view of the infrared camera. Further examples of parameters that influence the spatial distribution of infrared radiation comprise: the (e. g. material-dependent and/or roughness-dependent) reflectivity and/or emissivity of the surface emitting infrared radiation. For example, there are materials that reflect infrared radiation almost completely, e. g. glass or calm water surfaces, but also bare metal surfaces, and may therefore produce different “colour values” even at the same temperature. The surface roughness, for example, influences the so-called emissivity, e. g. for infrared radiation. Rusty or scratched steel, for example, emits considerably more infrared radiation than bare steel of the same temperature. These parameters have a considerable influence on the absolute temperature measurement. In other words, the image data sensed by the infrared camera is based on sensed infrared radiation, which is a function of a temperature of the source of the infrared radiation, i. e. this image data is based on infrared radiation (also referred to as infrared radiation-based). The image data may optionally be assigned to a temperature indication or (after an optional error correction of reflections or material parameters and/or surface parameters) converted into the temperature indication.

The colour information of the image data may, for example, represent the intensity of the infrared radiation recorded pixel by pixel or already encode the temperature indication. For example, the colour information of the image data may be monochrome or polychrome (e. g. in the case of a false colour representation).

Optionally, the infrared camera may be part of a camera system comprising multiple infrared cameras whose fields of view, for example, overlap. The multiple infrared cameras may optionally be configured to provide image data of the camera system's field of view from multiple optical perspectives (e. g. provided by using multiple lenses), e. g. stereoscopic image data. Stereoscopic image data facilitates the distinction between symmetrical and asymmetrical pick wear. However, stereoscopic image data may also be provided by using a single infrared camera, as will be described in more detail later.

A transducer may be understood as a sensor (also referred to as a detector) that is configured to sense a property of its environment (e. g. qualitatively or quantitatively) corresponding to the sensor type as a measured variable, e. g. a physical property, a radiation intensity, a chemical property and/or a material property. The measured variable is the physical variable (also referred to as the controlled variable) to which the measurement using the sensor applies. An example of a quantitatively recorded measured variable is, for example, radiation intensity, the actual state of which may be converted into a measured value using the sensor.

Each sensor may be part of a measurement chain which comprises a corresponding infrastructure (e. g. processor, storage medium and/or bus system and the like). The measuring chain may be configured to control the corresponding sensor (e. g. image sensing sensor), to process its sensed measured variable as an input variable and, based on this, to provide an electrical signal as an output variable that represents the sensed input variable. For example, the output variable may indicate the measured value. The measurement chain may for example be or be implemented using a data processing device.

Reference is made herein to a state of a machine pick (also referred to as pick state). The state of the machine pick may depend on one or more wear parameters, for example on the degree of wear (also referred to as progress of uniform, symmetrical wear) of the machine pick as a wear parameter and/or on a wear symmetry of the machine pick as a wear parameter (then also referred to as wear type). The target state of a pick may, for example, be the state of an unused machine pick. The actual state of the pick may deviate from the target state depending on the time and intensity of use.

In various embodiments, the pick state may be specified numerically (e. g. as a percentage or absolute value). Alternatively, or additionally, the pick state may be specified as a class from a group of classes (e. g. comprising class “unworn” and class “worn”). Then, the determination of the pick state may comprise selecting one or more classes from the group of classes (also referred to as classifying). It may be understood that the group of classes, e. g. per wear parameter, may comprise two or more classes, for example “high degree of wear”, “medium degree of wear” and/or “low degree of wear”.

Further examples of classes are those that comprise one or more of the following: the presence of the pick (“e. g. pick is missing”), if the pick requires maintenance (e. g. if the pick is blocked and/or if asymmetrical pick wear is beginning), if the pick needs to be replaced (e. g. if the pick wear is critical and/or if the remaining service life is zero), or the remaining service life of the pick (e. g. “Machine pick is OK” or “Machine pick at 75% of expected service life”).

In analogy to the degree of wear, the wear symmetry may be specified numerically and/or as a class from the group of classes (e. g. class “asymmetrical” and class “symmetrical” and optionally comprising intermediate stages thereof). Then the determination of the pick state may comprise classifying the actual wear symmetry, e. g. as “asymmetrical” or “symmetrical”. Symmetrical wear (e. g. abrasive wear) may occur, for example, if the machine pick is worn continuously and/or if the machine pick rotates around its pick axis during the excavation process. Non-symmetrical (also referred to as asymmetrical) wear may occur, for example, if a brittle fracture (e. g. of the carbide pin) occurs, if the carbide pin falls out due to improper bedding, or if the rotation of the machine pick is blocked around its pick axis during the excavation process (also referred to as pick blockage).

According to various embodiments, state monitoring (e. g. pick wear state monitoring) is implemented automatically with the aid of an infrared imaging process, particularly for underground working conditions where there is no visibility of the picks during cutting. Due to the extreme friction during cutting, the contact points of the pick with the rock heat up considerably. The heat generated is typically distributed from the pick tip through the pick head and the pick shaft to the pick holder by heat conduction, resulting in a different temperature distribution in each case that is clearly distinguishable from the components further away, which is sensed by one or more high-resolution infrared cameras. Due to continuous wear, the shape of the pick head, but also its surface roughness, changes significantly compared to the new state (e. g. the target state) during installation, not only in the event of sudden wear (e. g. break-out or total break-off). During cutting, the shapes of the pick heads are clearly detectable in the infrared image (colloquially also referred to as a thermal image), the corresponding contours may therefore be extracted using an image processing algorithm and compared with the reference image (corresponding to the target state). If a pick is lost during the cutting process, this is represented by the infrared image. For example, there will be a dark area at the position where the pick should be in the infrared image. For example, instead of the pick, the infrared image shows its background, e. g. other parts of the cutting head or the mining environment, until the pick holder itself comes into contact with the rock and heats up. This situation may also be detectable at an early stage by comparing it with the reference image, so that wear of the pick holder may be completely avoidable.

Various embodiments are based on high-resolution, fast infrared cameras and an analysis system (implemented, for example, using a processor) that is configured to process (e. g., analyze) immediately the image data (also referred to as recordings) provided by the infrared cameras (e. g., during or after the cutting phase) from the picks, which were significantly heated due to the massive interaction with the rock, and to visualize the result of the state analysis in the form of an evaluation map of the cutting drum with the pick positions (e. g., using a graphical user interface). The recording after the cutting phase may take place as long as the cutting head is warm or cooling down (for example, 2 to 5 minutes or even more after cutting). In this case, the period during which the machine is not cutting may be used to carry out the recording (in which the cutting head may be sensorially scanned).

In various embodiments, all picks are identified on each revolution of the cutting head, quasi-cyclically, for example, in connection with an angle sensor that senses the position of the cutting head, or based on their (e. g., stored) position and/or relative arrangement on the same, their geometric profile, which is clearly distinguishable due to the temperature difference, may be determined from multiple perspectives (also referred to as views) and compared with the target state.

A visualization of the evaluation map (also referred to as a condition map) may take place in the driver's cab, facilitating it for the user to track the condition of each pick (e. g. almost) in real time and to detect problematic signs of wear at an early stage. For this purpose, it is not necessary to determine the absolute temperature of the pick as such. Optional markers on the pick head surface facilitates image processing considerably.

According to various embodiments, one or preferably multiple infrared cameras are disposed near the cutting head equipped with picks, preferably but not limited to conical picks (for example, protected from rockfall), and continuously or periodically (for example, after completion of a cutting operation on the entire face height and/or width) record infrared images (colloquially referred to as thermal images) of the picks entering the recording area of the infrared camera with the thermal signature of the just executed cut or the completed cutting cycle from the cutting area. The shape or, for example, the three-dimensional profile of each pick is derived from the acquired infrared images and compared with the reference image at the time of pick installation. Depending on the result of this comparison, a wear state is assigned and visualized on a cutting drum map as a state map, for example, using coloured dots, numbers, code, or similar. In the case of exceedance of predefined values, an acoustic and/or visual alarm may be triggered, which informs the user about the exceedance through the determined state. Alternatively, or additionally, the alarm may initiate an emergency stop, for example, if a pick blockage or pick breakage is detected as the pick state.

Various embodiments are configured to distinguish between different types of wear during the determination of the pick state, which may have different effects on the urgency of a pick change, and thus contribute to a significant optimization of the operation of the excavation machine.

In contrast to conventional concepts, according to various embodiments, an evaluation of geometric profiles is carried out using imaging processes. This allows both the type of wear and the size of the affected area to be detected early, and the cutting machine to be operated proactively and/or without fixed inspection stops. Picks are ideally changed at an optimum time when the wear-related higher normal forces and the decreasing cutting performance are in a favourable ratio. Conventional concepts using infrared cameras ignore the geometrical shape (also referred to as geometry) and the wear surface of worn picks, and determine absolute temperature values of the pick.

According to various embodiments, the pick state may be reliably determined based on image data even if this image data comes from a pick that is currently not fully engaged in cutting and is already cooling down, or cut material adheres to it. This significantly improves the detectability of the changes in the shape of the pick.

According to various embodiments, an infrared-based shape sensing of the pick heads is carried out during operation. In contrast to conventional concepts, which only sense the absolute temperature of the pick tip, depending on both the rock and the operating conditions, using infrared cameras, according to various embodiments, even slight temperature differences may be sufficient to reliably determine the pick state, which is therefore significantly more robust against disturbances (such as dust and water). Another aspect according to various embodiments is a spatial shape detection of the rotationally mounted picks, which further improves the data basis for the determination of the pick state.

According to various embodiments, the individual degree of wear of each pick on the cutting head is determined, for example quantitatively during operation, and a corresponding gradual evaluation is assigned to each pick. It is also possible to identify the type of wear, for example to differentiate between asymmetrical wear (e. g. when parts of the pick tip break off) and symmetrical wear (e. g. with normal wear on all sides). The state analysis may take place during operation, and the results may be visually transmitted to the operator as well as directly to the power train, for example to trigger an emergency stop after pick breakage or to indicate the specific picks that need to be replaced to prevent more serious damage.

With conventional concepts, the actual temperature distributions and/or infrared images are required, for example by searching for the peak value of the temperature based on these.

In contrast, according to various embodiments, there is no evaluation of a temperature (e. g. absolute temperature), but an identification of the contour, for example of gradients, based on image data representing a spatial distribution of the infrared radiation intensity (clearly an infrared radiation intensity image), for example representing the associated radiation values. In some embodiments, one or more pick heads are determined (for example, its position and/or identity) based on the image data. Based on the image data, a 3D profile of the pick head may be extracted to compare this 3D profile with a reference profile (i. e. profile of the reference state), which is invariant to temperature.

This takes into account the fact that infrared images and temperature indication based on them may be susceptible to interference, for example due to differences in the emissivity for infrared radiation (also known as IR radiation), which may depend on the material and the surface condition. In contrast, according to various embodiments, it was recognized that the determination of a contour is less susceptible to interference than temperature indication (absolute values) or estimates of the pick state based on this.

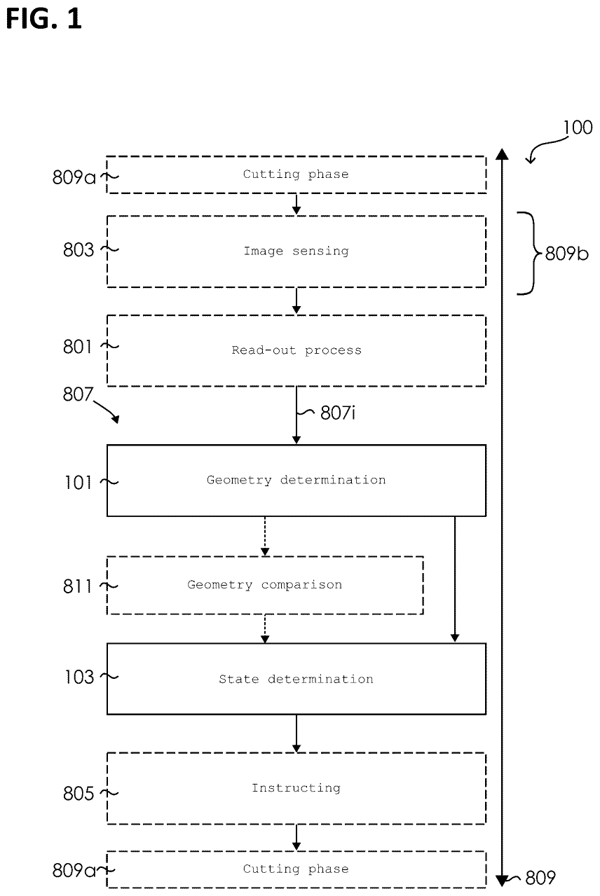

FIG. 1 illustrates a method 100 according to various embodiments in a schematic flowchart. The method comprises, in 101 (also referred to as geometrical determination 101), determination of an indication (also referred to as geometrical indication), representing the at least one (i. e. one or more than one) geometrical property of the pick; and in 103 (also referred to as state determination 103), determination of a state (also referred to as pick state) of the pick based on the indication. The pick geometry may be determined based on image data 807i, for example comprising one or more frames of the pick and/or representing the pick from multiple perspectives. The result of the state determination 103 may comprise the actual state (also referred to as the determined state) of the pick (also referred to as the actual pick state). Reference is made herein to a wear state as an exemplary pick state for ease of understanding. The described may also apply by analogy to pick states of other types.

To shorten the description, reference is made herein, inter alia, to a state analysis 807 (e. g. implementing a state monitoring) comprising the geometrical determination 101 and the state determination 103. Further, it may be understood that what is described herein for a single pick (e. g., processing of image data and the like) may apply by analogy to each pick of a group of picks (also referred to as a monitoring group).

Optionally, the method comprises one or more of the following: in 801, reading the image data 807 i from the infrared camera (also referred to as read-out process 801); in 803, capturing the image data using the infrared camera (also referred to as image sensing 803 or optical sensing); in 805, generating instructions (also referred to as instructing 805) based on a result of the state determination 103; in 809, excavation of a material (also referred to as material to be excavated) using the pick (also referred to as excavation process 809 or cutting process 809); and/or, in 811, comparison of the geometrical indication with a reference state of the pick (also referred to as geometrical comparison 811).

During the excavation process 809 (e. g. rock excavation processes), the pick 5 may be moved (also referred to as pick movement), for example repeatedly according to an excavation sequence which comprises a first phase 809a (also referred to as cutting phase or short cutting) in which the pick is in contact with the material to be excavated, and a second phase 809b (also referred to as idle phase) in which the pick 5 is at a distance from the material to be excavated. In the idle phase, the pick 5 may be moved, for example, along a closed path (also referred to as a pick path) away from the material to be excavated and/or towards the material to be excavated. If the material excavation process 809 is terminated (e. g. interrupted), the pick may still be moved along the pick path, but without touching the material to be excavated (also referred to as idle operation).

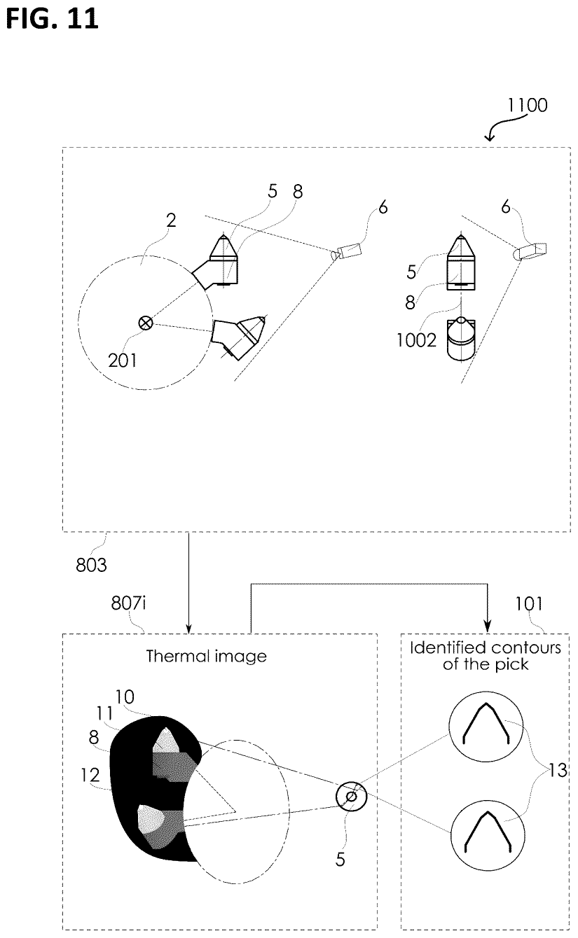

If the pick is attached to a so-called cutting head, the pick path may be circular (also referred to as circular movement) or defined by the revolution of a carrier chain fitted with picks. Alternatively, or additionally, the (e. g. circular) pick path along which the pick 5 is moved may lie in a so-called plane of rotation 1002 of the pick (see, for example, FIG. 11).

For example, the pick movement may take place, e. g. repeatedly according to the excavation sequence, while the read-out process 801 and/or the image sensing 803 takes place. Alternatively, the pick movement may be interrupted for the duration of the image sensing 803.

In some embodiments, the instructions may be generated according to a network communication protocol, e. g., as a message, or in the form of another signal. The instructions may optionally comprise an indication about the result of the state determination 103 (e. g., the determined state).

In a first exemplary implementation of the instructing 805, the instructions instruct to output the result of the state determination 103 or at least to provide a human-perceivable output based on the result of the state determination 103. The instructions may then be addressed to a user interface, for example, which is controlled using the instructions.

In the first or an alternative second exemplary implementation of instructing 805 the instructions comprise to change a movement of the pick, e. g. to stop, to slow down, to accelerate. The instructions may then be addressed to a power train, for example, which is controlled using the instructions. The power train may, for example, be configured to supply kinetic energy to the pick 5 (in order to drive the pick movement). For example, the instructions may instruct the power train to bring the pick to a standstill in a predefined position and/or to change its speed of movement. For example, the predefined position may be configured to facilitate the access to the pick (e. g. for inspection or changing it).

The image sensing 803 may optionally be synchronized with the pick movement (also referred to as synchronized image sensing), e. g. in such a way that their frequencies are dependent on each other. The synchronized image sensing may be implemented, for example, using a sensor (e. g. rotation angle sensor) that is configured to sense the pick movement (e. g. circular movement). For example, the rotation angle sensor may be configured to sense a rotation (e. g. the rotational frequency and/or rotational speed) of the cutting head. Control of the infrared camera may then be based on data originating from the sensor and/or representing the pick movement.

The duration of the complete circular movement may, for example, correspond to the duration of the excavation sequence. Inter alia, reference is made herein to the circular movement, wherein it may be understood that what is described may apply by analogy if the pick path is shaped differently.

However, the frequency of sensing may also be controlled by a specific position (height, lateral deflection) of the movable cutting head carrier or by a signal provided by the machine control system, e. g. in order to always sense the pick state after a complete cut over the entire face and for this purpose expose the camera to the harsh ambient conditions only briefly, outside the active cutting process.

Various implementations of the method 100 using an excavation system are explained below, which are to be understood as exemplary.

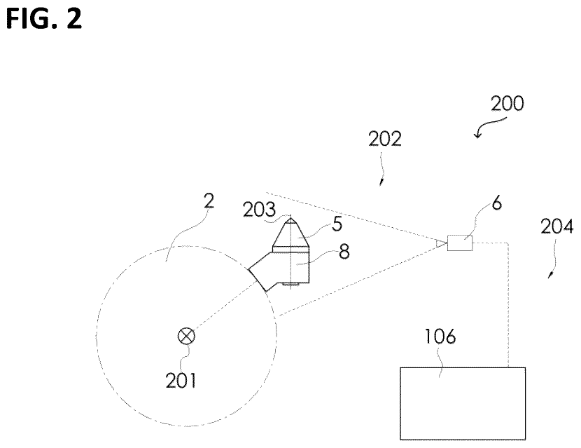

FIG. 2 illustrates an excavation system 200 according to various embodiments in a schematic layout diagram.

The excavation system 200 comprises an excavation machine 202 and an infrared camera 6. The excavation machine 202 comprises the pick 5 and is configured to excavate the material to be excavated using the pick 5, for example by pressing the pick 5 against the material to be excavated. The infrared camera 6 may be configured to sense image data. During operation of the excavation system 200, for example when the excavation process 809 is carried out using the excavation machine 202, the infrared camera 6 may be directed at the excavation machine 202, for example on its pick 5 or at least on the pick path, so that image data of the pick 5 may be sensed using the infrared camera 6.

The excavation system 200 further comprises a data processing device 106, which is configured to perform the method 100. In addition, the data processing device 106 may be communicatively coupled 204 to the infrared camera 6 during operation, e. g. wirelessly and/or by cable.

An exemplary implementation of the excavation machine 202 comprises a cutting head 2, which is configured to hold one or more picks 5. In addition, the cutting head 2 may for example comprise one or more so-called pick holders 8, of which each pick holder 8 is configured to hold a pick 5. The pick holder 8 may for example comprise a cavity (also referred to as a pick slot) to receive the pick 5 and an optional locking device (not shown). The locking device is configured to form-fitingly lock the pick 5 received in the cavity. This makes it possible to change the pick 5 quickly and cost-effectively. The cavity may optionally comprise an insert made of wear-resistant material, so-called wear bushing.

The cutting head 2 may form the last member of the power train of the excavation machine 202 (i. e. its kinematic chain). The power train may further comprise one or more drives configured to supply kinetic energy to the pick 5, for example by supplying torque to the cutting head 2 or by displacing the cutting head 2. The rotary movement of the cutting head 2 causes the pick 5 to move in a circular movement around the axis of rotation 201 of the cutting head 2. The frequency of the rotational movement of the cutting head 2 and the frequency of the circular movement of the pick 5 (also referred to as the rotational frequency of the pick 5) may be identical. The rotational frequency at which each pick appears in the camera's field of view may be in a range of approximately 0.2 Hz to approximately 2 Hz, for example approximately 0.5 Hz (which corresponds to 30 drum rotations per minute).

The cutting head 2 is rotatably mounted around the axis of rotation 201 (which is disposed within the cutting head 2). For example, the excavation machine 202 may comprise a bearing device comprising a pivot bearing that provides the pivot axis 201 (also referred to as the head axis 201). The head axis 201 may be transverse to the plane of rotation 1002 of each pick 5 that is moved using the cutting head 2.

Optionally, the bearing device may comprise an arm (also referred to as a boom) which holds the cutting head 2. In this case, the bearing device, e. g. its arm, may be configured to move the axis of rotation 201 of the cutting head 2, e. g. to displace and/or rotate it along a direction of movement (also referred to as a pivoting movement in the case of rotation).

If the pick is a so-called conical pick, it may be configured to be able to rotate in the pick slot around its pick axis 203 (also referred to as pick rotation or, in simplified terms, internal rotation). This improves the symmetry of the wear of the pick 5. The rotation of the pick axis may take place (e. g. only) in the cutting phase and/or be stimulated by the interaction with the material to be excavated (e. g. rock).

Examples of the excavation machine 202 comprise: a shearer, an excavator, a roadheader, a so-called continuous miner, a so-called surface miner, or a tunnel boring machine. In the following, some implementations of the excavation system 200 are first explained and then specific embodiments of the method 100 are discussed. In addition, reference is made to image data on which the geometrical determination 101 is based, which are provided by a camera system. It may be understood that what is described for the image data from the camera system may apply by analogy to image data provided by exactly one or more infrared cameras.

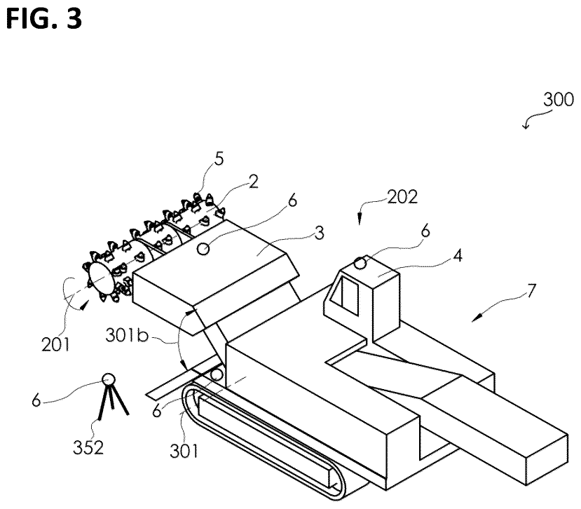

FIG. 3 illustrates an excavation system 200 according to various embodiments 300 in a schematic perspective view, in which the excavation machine 202 is configured as a so-called continuous miner 7 (also referred to as a “continuously cutting machine”). The continuous miner 7 comprises one or more cutting heads 2, which is configured as a transverse cutting head. The cutting head may be cylindrical (then also referred to as a cutting drum).

The pivoting movement 301b of the excavation machine 202 may be about an axis of rotation 301, which is disposed parallel to the head axis 201 and outside the cutting head 2. Alternatively, or additionally, the bearing device 3 may be configured to displace the head axis 201 along one or more translation axes and/or to rotate about one or more additional rotation axes (see arrows).

Furthermore, the excavation system 200 may comprise one or more infrared cameras 6, exemplary mounting positions of which comprise: on the boom 3 (e. g. front or rear side of the boom 3), on the user cabin 4 of the excavating machine 202, next to the excavating machine 202 (e. g. supported on a base of the excavating machine 202), on a chassis of the excavating machine 202.

An exemplary implementation of the infrared camera 6 disposed adjacent the excavation machine 202 may be carried by a stand 352 comprising one or more feet (e. g., a tripod) disposed on a base on which the excavation machine 202 is disposed. Alternative or in addition to the foot, the stand 352 may also comprise a handle to be carried by the user. This improves the flexibility of the excavation system 200

In general, it should be noted that any other mounting position may also be selected, provided that it allows an infrared camera 6 mounted there to be directed at a pick 5 so that the pick path is at least partially disposed in the field of view of the infrared camera. The geometrical determination 101 may be based on the image data from only one infrared camera 6 or on the image data from several infrared cameras 6, which differ from each other in their mounting position. The more infrared cameras 6 or different mounting positions are used, the better the data basis for the geometrical determination 101, as will be explained in more detail later.

Optionally, the image data may be displayed directly using a graphical user interface, e. g. its display device in the cabin 4, or on a remote control and monitoring unit.

As shown, the cutting head 2 may comprise several picks 5 that differ from one another in the pick path along which they are moved. Alternatively, or additionally, the cutting head 2 may comprise several picks 5 that match in the pick path along which they are moved. It should be noted, however, that it is not absolutely necessary for the movement path of each pick 5 on the cutting head 2 to be disposed in the field of view of an infrared camera 6 of the camera system. In other words, the monitoring group does not have to comprise all the picks. A kind of random state analysis 807 may just as well take place.

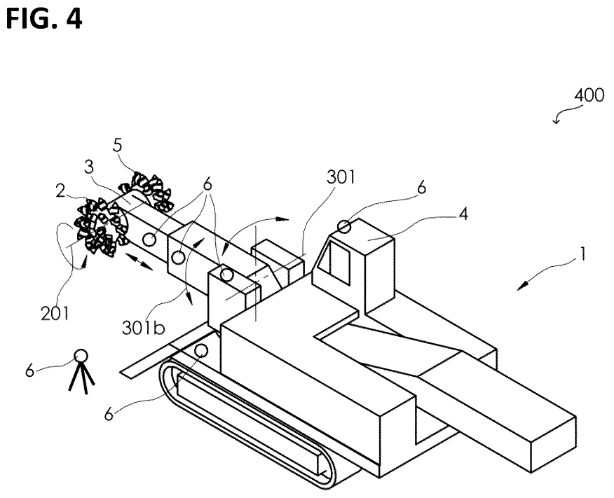

By analogy with the embodiments 300, FIG. 4 illustrates the excavation system 200 according to various embodiments 400 in a schematic perspective view, in which the excavation machine 202 is configured as a so-called roadheader 1. The roadheader 1 comprises one or more cutting heads 2, which is configured as a transverse cutting head. For example, the boom 3 may be disposed between two transverse cutting heads.

Reference is made herein by way of example to the roadheader and likewise to the continuous miner, it being understood that what is described for the roadheader may apply by analogy to the continuous miner and vice versa, and likewise to an excavation machine of a different type.

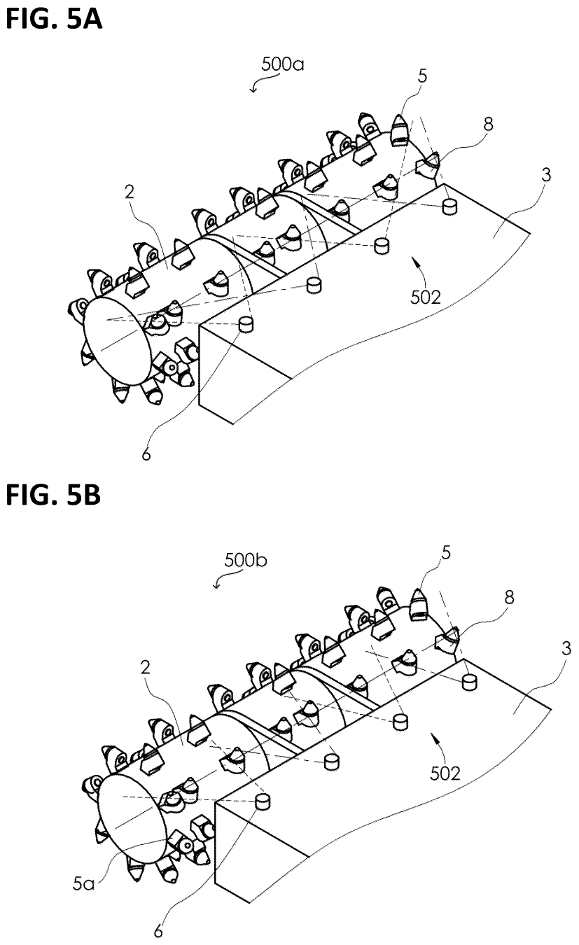

FIGS. 5A and 5B each illustrate the excavation system 200 according to different embodiments 500a, 500b in a schematic perspective view looking at the cutting head 2, which differ from each other in the configuration of the camera system 502. As implied above, the camera system 502 may comprise a plurality of infrared cameras 6 which are mounted, for example, on the boom 3, and from which the image data, on which the geometrical determination 101 is based, originates.

According to embodiments 500a, the camera system 502 is configured (e. g. disposed and aligned) such that each pick 5 of the monitoring group is moved through the field of view of more than one infrared camera 6 of the camera system 502 per revolution of the cutting head 2. The image data then comprises several frames of the pick per pick and per circular movement, which differ from one another in their viewing angle (also referred to as perspective). This facilitates the determination of the degree and/or type of wear more reliably, as will be explained in more detail later.

In an exemplary implementation of embodiments 500a, the camera system 502 is configured to sense stereoscopic image data of one or more picks 5. For example, directly adjacent infrared cameras 6 of the camera system 502 (also referred to as a camera pair) are configured in such a way that their fields of view on the cutting head 2 overlap. For example, the stereoscopic image data has two frames of the pick 5 per pick 5 and per circular movement of the pick 5 (e. g. in the same position and/or at the same time), which differ from each other in their respective viewing angle (also referred to as perspective).

According to embodiments 500b, the camera system 502 is configured to sense only monoscopic image data of one or more picks 5. For example, directly adjacent infrared cameras 6 of the camera system 502 are configured in such a way that their fields of view on the cutting head 2 are adjacent to each other or comprise at least a distance from each other. The embodiments 500b are advantageous, for example, if fewer infrared cameras 6 are available per pick, if a higher image resolution is required, or if the available infrared cameras 6 comprise too low resolution to sense several picks 5 with sufficient accuracy.

According to embodiments 500b, for example, each pick 5 may be moved through the field of view of exactly one infrared camera 6 per revolution of the cutting head 2. For example, the pick may be sensed from only one perspective per revolution of the cutting head 2.

The image sensing 803 according to embodiments 500b may be sufficient (e. g. equivalent to embodiments 500a) if the pick 5 is configured for self-rotation (which may be the rule for conical picks). This is because in this case, the rotational position of the pick relative to the infrared camera 6 at the time of image sensing differs at least slightly during successive circular movements due to the rotation of the pick. The successive frames therefore likewise differ in the perspective from which the pick 5 was sensed optically.

If the pick rotation is blocked (also referred to as a pick blockage), the pick in embodiments 500b but also embodiments 500a is repeatedly sensed in the same position one after the other. This pick blockage may therefore be determined using a comparison of the successively sensed image data or using geometrical comparison 811, as will be explained in more detail later. For example, the state determination may determine the pick blockage as a pick state if the result of a comparison of the successively sensed image data or the result of the geometrical comparison 811 falls below a threshold value.

In a non-shown exemplary implementation of embodiments 500a, the excavation system 200 comprises a plurality of camera systems 502 according to embodiments 500b, between which the boom 3 is disposed. Clearly, one of the camera systems 502 may be directed at a lower portion of the cutting head 2 and one of the camera systems may be directed at an upper portion of the cutting head 2.

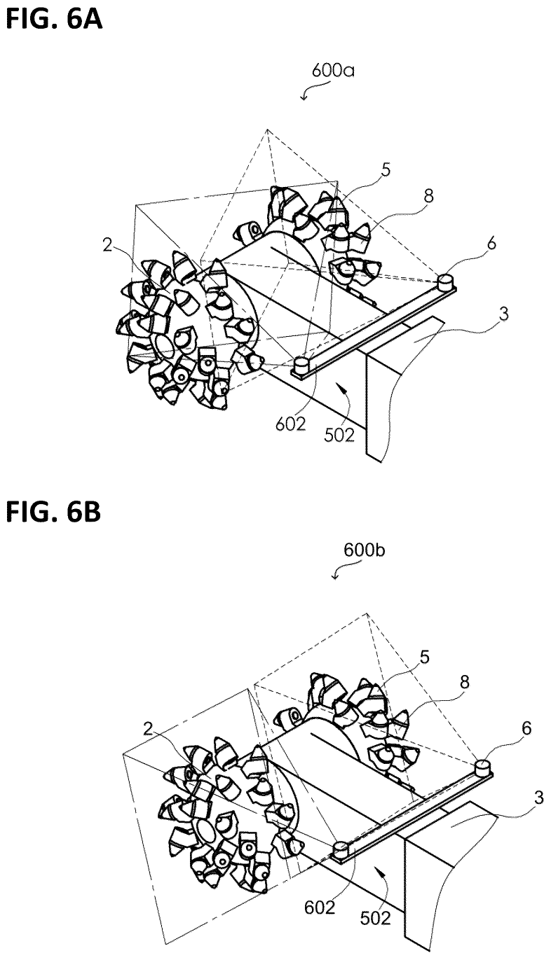

FIGS. 6A and 6B each illustrate the excavation system 200 according to different embodiments 600a, 600b in a schematic perspective view with a view of the cutting head 2, which differ from one another in the configuration of the camera system 502 analogous to embodiments 500a, 500b. In contrast to this, the bearing device 3 additionally comprises a crossbeam 602, which protrudes above the boom and carries the camera system 502. The crossmember 602 improves the perspective of the camera system 502 and therefore improves the data basis for the geometrical determination 101.

For example, each cutting head 2 may be associated with an infrared camera 6 which is directed at the cutting head 2, for example such that its field of view senses the (e. g. entire) cutting head 2. For example, the entire cutting head 2 may be disposed in the field of view of the infrared camera 6 assigned to it (see embodiments 600b).

Analogous to embodiments 500a, the camera system 502 according to embodiments 600a is configured (e. g., disposed and oriented) in such a way that the or each pick 5 is moved through the field of view of more than one infrared camera 6 of the camera system 502 per revolution of the cutting head 2, e. g., such that stereoscopic image data of at least one (i. e., one or more than one) pick 5 is sensed.

Analogous to embodiments 500b, the camera system 502 according to embodiments 600b is configured (e. g. disposed and aligned) in such a way that the at least one pick 5 is moved through the field of view of exactly one infrared camera 6 of the camera system 502 per revolution of the cutting head 2, e. g. so that only monoscopic image data of the at least one pick 5 is sensed.

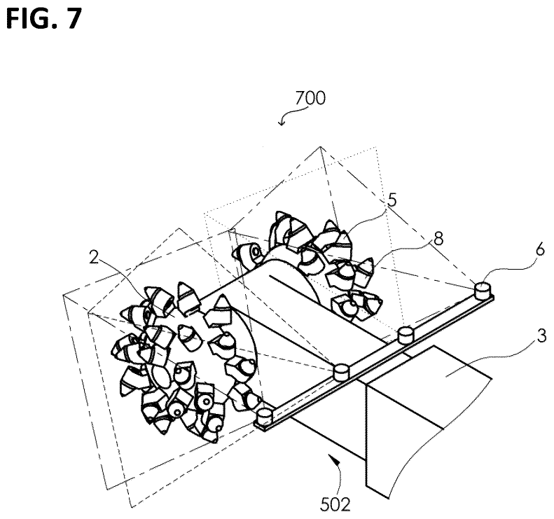

FIG. 7 illustrates the excavation system 200 according to various embodiments 700 in a schematic perspective view with a view of the cutting head 2 analogous to embodiments 600a, 600b, but with the difference that two infrared cameras 6 (also referred to as a camera pair) are assigned to each cutting head 2, which are directed at the cutting head 2, for example in such a way that their field of view senses the (e. g. entire) cutting head 2. This further improves the data basis. Naturally, more than two infrared cameras may also be present per cutting head 2 and directed at the cutting head 2.

Analogous to embodiments 600a, each pair of cameras whose infrared cameras 6 are directed at a cutting head 2 may be configured (e. g., disposed and oriented) in such a way that stereoscopic image data of the cutting head 2 is sensed.

Various exemplary implementations of the method for the embodiments of the camera system mentioned herein are explained below.

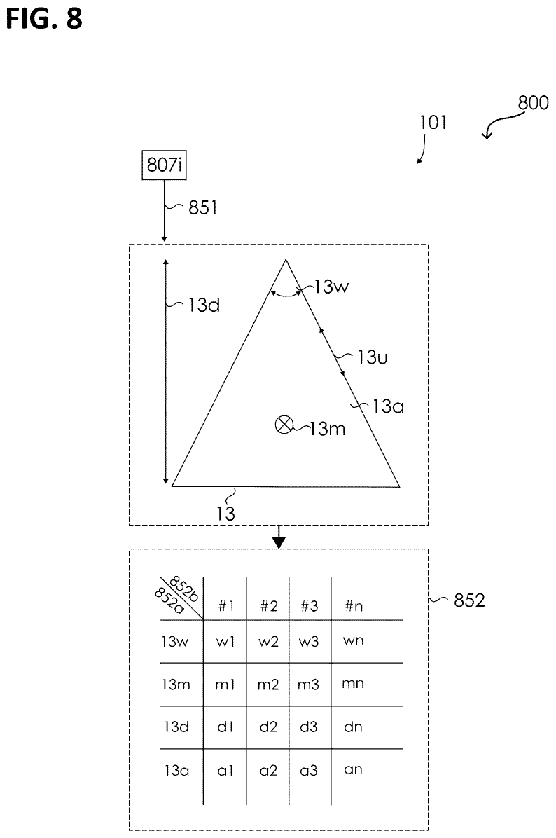

FIG. 8 illustrates the geometrical determination 101 according to various embodiments in a schematic diagram 800. The geometrical determination 101 may be configured to process the image data 807i as input and output the geometrical indication 852 (as a result of the geometrical determination 101).

The geometrical determination 101 may comprise, in 851, determining a data-based representation 13 (also referred to as a geometrical representation 13) of a geometry of the pick 5 (e. g., here exemplified by the contour 13 of the pick head) based on the image data. The geometrical representation 13 may represent one or more of the following geometrical properties of the pick (e. g. the pick head): a contour; a cross-sectional area enclosed by the contour of the pick (e. g. the pick head) and/or a planar projection (from the viewing angle of the infrared camera) thereof; a geometrical extension.

The determination 851 of the geometrical representation 13 may, for example, take place using one or more image processing algorithms. The image processing algorithm may, for example, comprise a filter (also referred to as an image filter or graphics filter) that is configured to output, for each frame, a plurality of image components (e. g. pixel coordinates) of the frame that fulfil a predetermined criterion (also referred to as filtering out). Examples of the image processing algorithm comprise: an edge detection, a Fourier high-pass filter, a threshold filter, a Fourier low-pass filter, a colour value difference analysis, an object detection, a geometry detection, a trained algorithm. The algorithm may be trained using machine learning, for example, based on training data which comprises image data of picks of known geometry.

The trained algorithm may be, for example, a single-layer or multi-layer artificial neural network (ANN) in conjunction with a gradient descent method. The network may, for example, be a feedback or feedforward multilayer perceptron. The ANN may perform a self-learning classification, for example with learning vector quantization, it may contain random or statistical learning variables (probabilistic ANN) or process time-delayed indication from previous runs in order to achieve a better classification (time-delayed ANN).

Alternatively, or additionally, the geometrical representation 13 may generally be determined using any process of planimetry.

For example, the colour value difference analysis may comprise a difference criterion as a criterion that is fulfilled for an image component (e. g. a pixel) if a difference between the colour value of the pixel and adjacent pixels exceeds a threshold value. This facilitates the determination of the contour of the geometrical representation 13. By analogy, a threshold value of a gradient of an equalization calculation based on several colour values may serve as a criterion. Alternatively, or additionally, those image components may be filtered out whose colour value exceeds a threshold value and/or whose difference between the colour value of the pixel and adjacent pixels falls below a threshold value (also referred to as a homogeneity criterion). This facilitates the determination of the area of the geometrical representation 13.

The geometrical indication may comprise one or more properties of the data-based geometrical representation 13 (also referred to as geometrical property) or at least be derived therefrom. Examples of the geometrical property comprise: a circumference 13u of the geometrical representation 13; a (e. g. geometrical) centre of gravity 13m (preferably of the planar projection enclosed by a contour of the pick), e. g. its position; an area of the surface 13a (e. g. representing the cross-sectional area of the pick); an angle 13w, which is enclosed by two edges of the geometrical representation 13 (e. g. at the pick tip, also referred to as wedge angle 13w); an extension 13 d of the geometrical representation 13 (e. g. starting from the pick tip, e. g. along the pick axis, also referred to as pick height); one or more geometrical properties of a thermal marker (also referred to as marker property), which will be discussed in more detail later.

Each of these geometrical properties may, by itself, be a sufficient basis to perform a reliable state determination 103 based thereon. However, it may be understood that the reliability of the state determination 103 may be improved if the geometrical indication 852 comprises multiple geometrical properties that may optionally be weighted. Weighting achieves an additional degree of freedom to adapt the method 100 to sources of interference of different types and thus compensate for them.

Shown is a multi-component geometrical indication 852, comprising multiple numerical values as components (here exemplified as w_1, . . . , w_n; m_1, . . . , m_n; d_1, . . . , d_n; a_1, . . . , a_n) and expressed herein in vectorial form to shorten notation. The multi-component geometrical indication 852 improves the reliability of the information on which the state determination 103 is based. Expressed in this vectorial notation, the multi-component geometrical indication 852 may comprise one or more dimensions, each dimension referencing a property in which the values differ from each other (e. g., a time, a type, etc.).

For example, a first dimension 852a of the geometrical indication 852 may reference a type of the geometrical property. Alternatively, or additionally, a second dimension 852b of the geometrical indication 852 may reference the frame (here exemplified as #1, #2, etc.) on which the geometrical indication 852 is based, e. g. its image number and/or its time, and/or in another way reference a time history. More or fewer properties of geometrical indication 852 may naturally be referenced. For example, the perspective on which the component is based may be alternatively or additionally referenced, e. g. per pick and/or circular movement of the pick.

In the exemplary matrix shown, all entries of column #1 may be based on the same frame or several frames of the same moment in time. Alternatively, or additionally, all entries of the row of angle 13w may indicate the value of an angle 13w enclosed by two edges of the geometrical representation 13 (e. g., at the pick tip). The entries along the second dimension 852b then map the progression of the geometrical properties over time, which facilitates the detection of small changes in the pick geometry.

Optionally, the state determination 103 may be based on a numerical value that is a function of (e. g., weighted) values of multiple geometrical properties of different types and/or different moments in time. This improves the reliability of the information on which the state determination 103 is based. Weighting the values of multiple geometrical properties of different types and/or different moments in time facilitates the adaptation of the method to the specific application.

Optionally, the image processing algorithm may comprise an algorithm that is configured to convert a preliminary stage of the geometrical representation 13 into the geometrical representation 13. An example of this is the smoothing of the surface 13a, the contour 13u or the like. An alternative or additional example is an adjustment calculation that converts a collection of pixel coordinates into a vector-based path. The path may, for example, be a polyhedron, which is used as contour 13u, and/or be smoothed. The same applies analogously to the nodes of the path.

As explained above, the method 100 optionally comprises the geometry comparison 811. In that case, the state determination is based on a result (also referred to as comparison result) of the geometrical comparison 811. In a first exemplary implementation thereof, the geometrical indication 852 is compared with a (e. g. stored) target state of the pick as reference state (also referred to as absolute comparison), e. g. with a target geometrical indication. In the first or an alternative second exemplary implementation thereof, the geometrical indication is compared with a previous (e. g. stored) geometrical indication of the same pick as a reference state (also referred to as relative comparison). This may optionally be necessary if a newly inserted, practically unused pick comprises different surface properties than a used pick and therefore makes contour detection more difficult. The target geometrical indication might then be determined after a defined low number of operating hours, for example. The relative comparison may alternatively or additionally comprise comparing several components of the geometrical indication of the same type with each other, provided that the geometrical indication is time-dependent.

The absolute comparison facilitates the comparison of several picks with each other and/or allows the remaining service life of a pick to be determined. The relative comparison improves the reliability of the process.

In an exemplary scenario, the geometrical property (e. g. contour) of the pick is superimposed by rock material adhering to it. However, errors due to this superimposition may be avoided by a statistical comparison with the previous images as a relative comparison and an instruction to issue a slightly delayed warning (as a signal). Alternatively, or additionally, the adhering material may appear darker in an absolute comparison due to the lower thermal conductivity and differences in emissivity and may therefore be distinguishable from the actual pick.

The method 100 may optionally comprise classifying the determined geometrical indication 852 and/or the underlying image data as invalid (also referred to as discarding) based on a result of the geometrical comparison 811. In this case, the state determination 103 may optionally be configured to ignore all geometrical indication 852 classified as invalid. In an exemplary implementation of discarding, this may be based on the result of the relative comparison, for example if a deviation of the actual geometrical indication from the previous geometrical indication exceeds a threshold value. For example, a pick contour may only be classified as valid if it occurs repeatedly in a similar form and otherwise be discarded as an outlier.

Various implementations of the method 100 in which the geometrical representation 13 is determined are explained below.

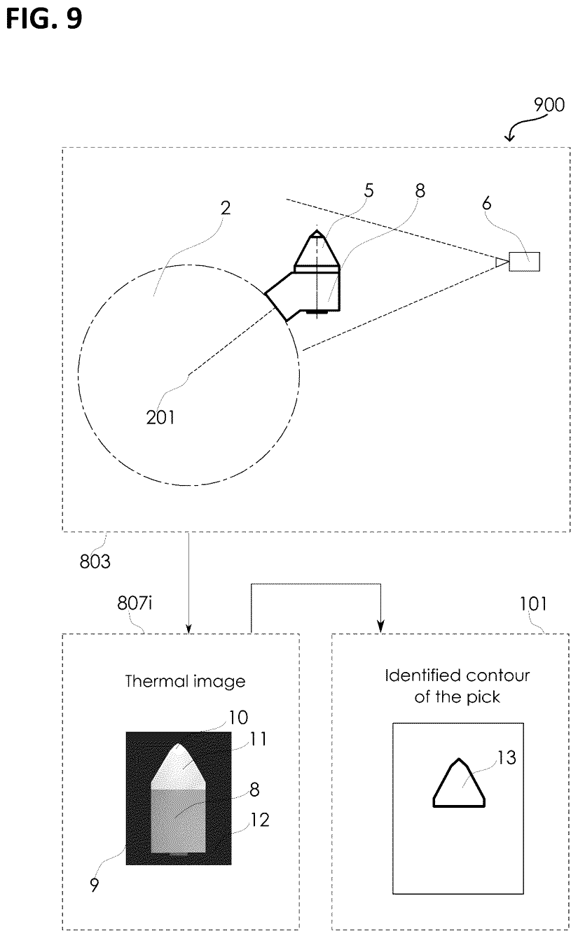

FIG. 9 illustrates the method 100 according to various embodiments in a schematic flowchart 900. The image sensing 803 and/or the camera system 502, using which the image sensing 803 is performed, may be configured to sense image data 807i comprising exactly one frame 9 per (e. g. n) circular movement(s) of the pick 5 around the rotation axis 201 (n may for example be 1 or more). For example, the image sensing 803 may be synchronized with the circular movement of the pick 5, e. g. such that a frequency of the image sensing f_B (also referred to as image sensing frequency) is a function of the rotational frequency f_D of the pick 5. For example, the relation may be fulfilled: n·f_D≤f_B, wherein n is a natural number.

It may be advantageous if the state analysis 807 is performed individually for each pick 5 on the cutting head 2, i. e. that the monitoring group comprises all picks 5 on the cutting head 2. Therefore, it may be understood that the processing of image data described herein may be performed by analogy for each pick 5 on the cutting head 2, but need not necessarily be so. It may also be sufficient not to perform the state analysis 807 for all picks 5 at the cutting head 2 in order to save resources. In that case, the monitoring group may comprise only a portion (e. g., less than 90% or less than 75%) of the picks 5 at the cutting head 2.

It may further be advantageous if the state analysis 807 of each pick 5 of the monitoring group is based on at least one frame of the pick 5 per time interval. The time interval may, for example, be the duration of a complete circular movement of the pick 5 (i. e. 1/f_D). In that case, the pick 5 may be optically sensed each time it passes the camera system. However, the more picks 5 the cutting head 2 holds, for example, this may exceed the image sensing frequency at which the camera system 502 provides reliable frames. In this case, or for other reasons, it may also be sufficient if n times the duration of a circular movement of the pick 5 is used as the time interval. It may further be advantageous to adjust the image sensing frequency to the work sequence, for example after each full cut on the face while the machine is idle and moves the boom to a new starting position.

As part of the image data 807i, a temperature-based frame 9 (also referred to as infrared image 9) of the pick 5 during the excavation process 809 is shown here as an example. Due to the mechanical friction of the pick 5 on the material to be excavated during the excavation process 809, thermal power is introduced into the pick 5 (mainly at the tip of the pick), which leads to heating of the pick 5. This is counteracted by the cooling of the pick through the emission of infrared radiation and heat transfer to its environment (e. g. through heat conduction in the pick and at contact points on the pick holder). Cooling and heating reach an equilibrium when the pick reaches the so-called operating temperature, around which the actual temperature of the pick 5 fluctuates in the cycle of the circular movement and/or the excavation sequence. In normal operation, without increased wear events such as blockages, the average operating temperature of the pick may be greater than about 150° C., for example, or than about 250° C., while at the tip more than 750° C., for example, may be reached for a short time even in normal operation.

The release of heat from the pick to the pick holder, for example, is a function of the thermal conductivity of these, the contact area of these with each other and the contact time of these with each other.

In simplified terms, there is a heat flow from the pick tip 10 through the pick head 11 to the pick holder 8 or at least the pick shaft, which leads to a temperature gradient that is represented by the colour information of the infrared image 9. For example, a higher brightness value of the infrared image 9 corresponds to a higher temperature and thus to the pick head 11.

This temperature gradient arises shortly after the start of the excavation process 809 (for example after a short cutting phase) and may also be sensed during the entire circular movement of the pick, even if the pick is only in contact with the material to be excavated for a fraction of the circular movement. This likewise applies to the time during which the excavation process 809 is interrupted, for example when there is no cutting, which may be the case when repositioning after cutting a face height from top to bottom or vice versa with a roadheader or a continuous cutting machine.

Depending on the specific implementation, image sensing may only take place when the excavation process 809 is interrupted, i. e. when no pick is in contact with the material to be excavated and/or the excavation machine 202 is at a distance from the material to be excavated.

In one embodiment (e. g., the case explained above, preferably where recordings are made during cutting where the danger is particularly high), the excavation system may comprise a camera protection device that protects (e. g., covers) the camera system (e. g., one or more camera lenses thereof) from solid particles (e. g., flying debris) from the excavation process 809. However, it may be understood that the camera protection device may alternatively or additionally be used in other instances, as will be described in more detail later.

In another implementation, image sensing may be performed when the excavation process 809 is performed using the cutting head 2 (e. g., a cutting drum 2), e. g., when the pick is in the idle phase of its pick path, or even in an idle mode (e. g., in an idle rotation) after the excavation process 809. Optionally, the pick 5 and the pick holder 8 may be sensed in multiple perspectives.

When the infrared camera 6 starts image sensing (also referred to as recording) after or even during an excavation process 809, the pick 5 is easily detectable in the infrared image 9 due to the temperature gradient to the pick holder 8, the cutting drum 2 and/or the environment, for example using the image processing algorithm or another process of image processing. On the infrared image 9 from the infrared camera 6, the highest temperature is detected at the pick tip 10 (e. g. based on the brightness), followed by the pick head 11 and pick holder 8.

If the temperature is coded using brightness values, the image area with the highest temperature in the infrared image 9 is the brightest, the background 12 (this may be either the cutting drum 2 or the environment) is slightly darker. In this case, the geometrical determination may be used to determine the pick contour 13 of the pick head 11 as geometrical representation 13 based on the bright image area of the infrared image 9.

If the pick 5 and the pick holder 8 differ in their thermal conductivity and/or in the material of which they are made, differences in temperature between them are even greater and thus easier to determine. However, the radiation emitted by the bodies detected in the infrared image may also depend on the emissivity of the surfaces of the bodies, so that bodies with the same temperature may be displayed differently on the sensed infrared image, e. g. a new pick (or pick holder), a worn pick (or pick holder) and a corroded pick (or pick holder). Picks with scratches, adhering dirt and corrosion emit infrared radiation better than new picks with a comparatively smooth surface, so that the longer they were in use, the better their contours are detectable on the infrared image.

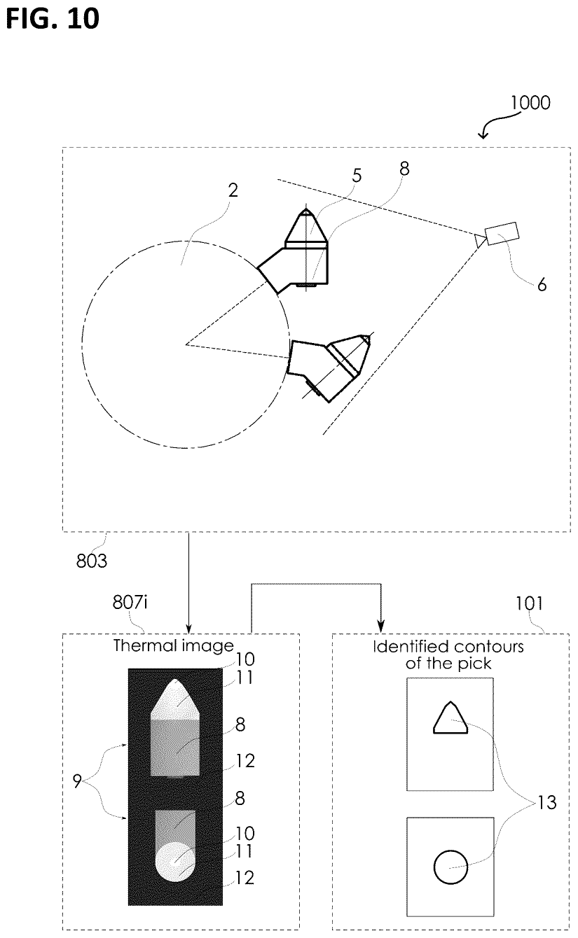

FIG. 10 illustrates the method 100 according to various embodiments in a schematic flowchart 1000 similar to the flowchart 900, with the difference that the camera system 502 senses (e. g. per circular movement) several frames of the pick 5, which differ from each other in perspective (also referred to as image perspective). For example, the multiple frames (infrared images) are sensed using the same infrared camera 6 from different angles.

FIG. 11 illustrates the method 100 according to various embodiments in a schematic flow diagram 1100 similar to the flow diagrams 900, 1000, with the difference that the infrared camera 6 is arranged next to a plane 1002 (also referred to as the plane of rotation) in which the pick path is disposed (also referred to as the lateral perspective). The image sensing 803 is shown on the left with the viewing direction along the head axis 201 and on the right with the viewing direction transverse to the head axis 201.

This lateral perspective may result, for example, if several pick paths disposed next to each other run through the field of view of the same infrared camera 6. However, a lateral perspective may also result if the pick axis of a pick 5a (see FIG. 5B) is at an angle to the plane of rotation 1002 of the pick 5a, which appears, for example, at the edge sections of a cutting head 2 (e. g. a cutting drum 2) if a laterally directed excavation process 809 is to be favoured.

In the case of the lateral perspective, it is possible to determine several geometrical representations 13 that correspond to different perspectives of the cutting head 2 using the same infrared camera 6. This offers the same possibilities as the evaluation using stereoscopic image data sensed by several infrared cameras (which correspond to the same image sensing time).

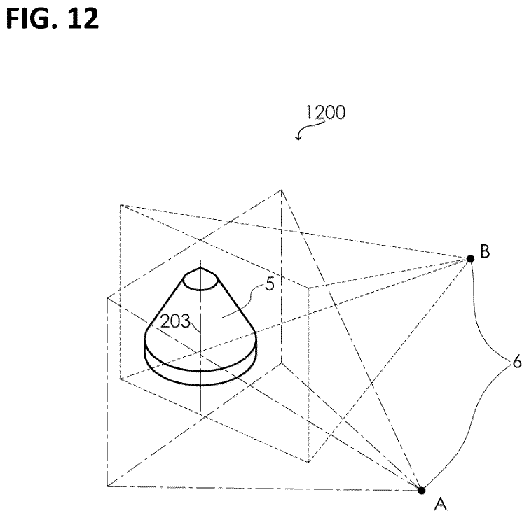

FIG. 12 illustrates a configuration of the camera system during image sensing 803 according to various embodiments in a schematic perspective view 1200, for example analogous to the image sensing 803 of the flow charts 900, 1000 and/or 1100. The camera system may comprise two or more infrared cameras 6, which sense the pick 5 (e. g. at the same time) from different perspectives (also referred to as stereoscopic view). This facilitates the provision of stereoscopic image data. This stereo view makes it easier to determine a fluctuation in the pick geometry and/or to determine a dependency of the pick geometry on the perspective. This facilitates the distinction between symmetrical and asymmetrical pick wear as a wear type.

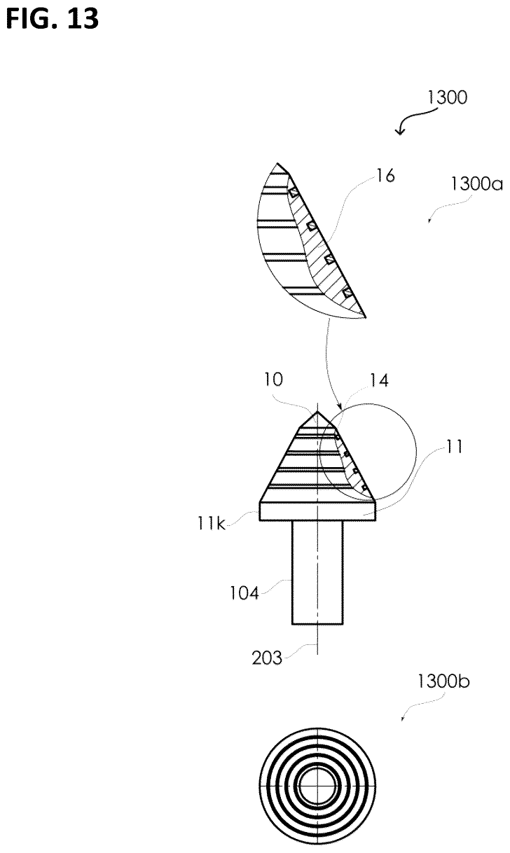

FIG. 13 illustrates a pick 5 according to various embodiments 1300 in a schematic side view 1300a with viewing angle transverse to the pick axis 203 and a schematic top view 1300b with viewing angle along the pick axis 203, in which the pick 5 comprises a marker 14 (also referred to as thermal marker 14, wear marker or in short as marker) on the pick head 11. According to various embodiments, it was clearly recognized that such a thermal marker 14 is identifiable from the image data and stands out from the rest of the pick 5. For example, it was observed that already fresh scratches on a brand-new pick appear darker in the infrared image.

The thermal marker 14 may comprise one or more segments (also referred to as a marker segment). The thermal marker 14 of the pick 5 (for example, each marker segment thereof) may differ from the pick head 11 (for example, the thickening 11k and/or the pick tip 10) in at least one thermal property, for example, a thermal emissivity and/or a thermal conductivity. This achieves that the thermal marker 14 becomes visible in the infrared image as an inhomogeneity, for example even with small temperature differences and/or if the heat flow through the pick 5 is time-invariant.

The thermal marker 14 may, for example, be made of ceramic (e. g. tungsten carbide), aluminum brass, aluminum, bronze, stainless steel, enamel or brass. In addition, grooves may be made on the pick head so that the cut rock clogs the grooves, thereby creating corresponding thermal marker(s) continuously during operation.

Exemplary implementations of the thermal marker 14 (for example, each marker segment thereof) are formed using a coating and/or a material of different thermal conductivity and/or emissivity than the pick head 11. Exemplary implementations of the thermal marker 14 (for example, one or more marker segments thereof) are embedded in, cut out of, or applied as a coating to the pick head 11.

Exemplary implementations of the thermal marker 14 (for example one or more marker segments thereof) are diposed between the thickening 11k and the pick tip 10.

For example, the geometrical indication may be based on the thermal marker 14, which makes the geometrical determination 101 more reliable. More descriptively, an incomplete and/or deformed thermal marker 14 may indicate where and/or in what way the pick 5 is worn (e. g. on its outer surface), whereas a profile image only ever represents the wear along the contour line.

If the pick 5 comprises the thermal marker 14, the geometrical representation 13 (e. g. per marker segment) may comprise or consist of a data-based representation (also referred to as a marker representation) of a geometry of the thermal marker 14 of the pick 5. Examples of the geometrical property (in this case also referred to as marker property) derived from the marker representation in this case comprise a perimeter 13u of a marker representation; a (e. g. geometrical) centre of gravity 13m (preferably of the planar projection, which is enclosed by a contour of the thermal marker or at least of a marker segment) of the marker representation, e. g. its position; an area of the surface of the marker representation; an angle enclosed by two edges of the marker representation; an extension of the marker representation; a number of marker segments.

As shown, the thermal marker 14 may comprise several strip-shaped (then also referred to as stripes) and/or ring-shaped marker segments that run around the pick axis 203. With increasing wear, these stripes 14 disappear, resulting in a different infrared image 9.

The thermal marker 14 clearly provides a means which may be taken into account in the infrared image as an alternative or in addition to the planar geometry of the pick 5 in order to determine the wear condition (e. g. degree of wear) of the pick.

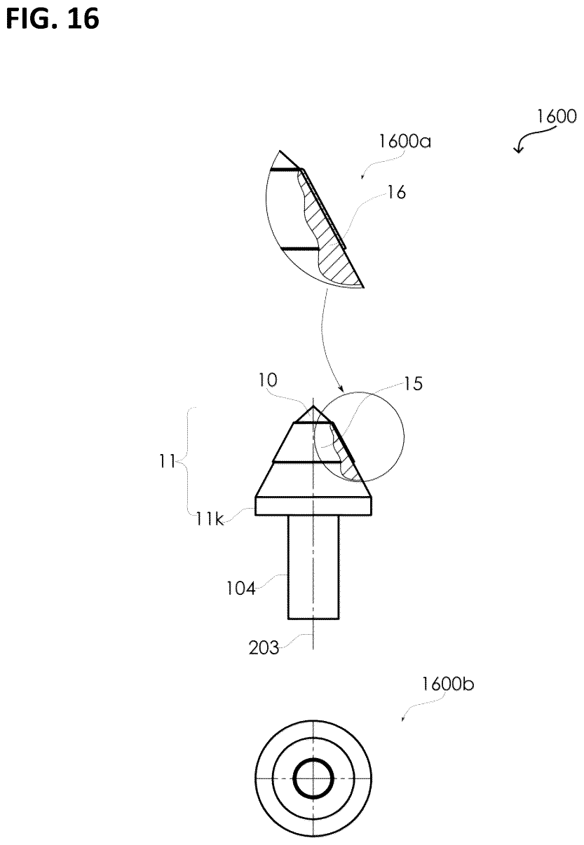

In an exemplary implementation, the strips 14 are embedded in the pick head 11. In another exemplary implementation, the pick head 11 is coated with the strips 14, which comprise a different thermal conductivity and/or emissivity than the underlying pick head 11. The erosion of such a coating 15 (see also FIG. 16) is detected step by step in the infrared image as a difference from the reference image pattern. In another exemplary implementation, the strips 14 are cut out of the surface of the pick head and fill with cut material during operation.

The state analysis 807 may, for example, be based on several strips 14 or a coating 15 of the pick 5 to determine the wear on the pick head 11 in the infrared image 9. Using the state analysis 807, which comprises determining one or more geometrical properties of the strips 14 or the coatings 15, the state of wear may be determined, for example the degree of wear may be quantitatively estimated.

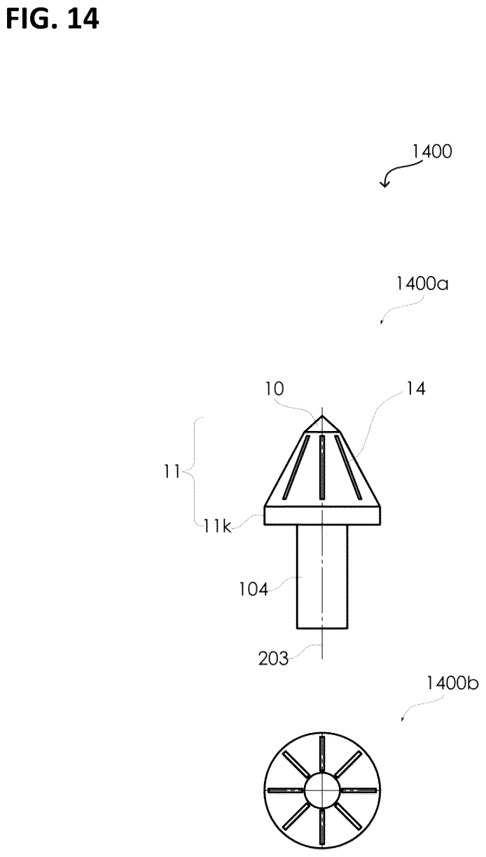

FIG. 14 illustrates a pick 5 in a schematic side view 1400a with viewing angle transverse to the pick axis 203 and a schematic top view 1400b with viewing angle along the pick axis 203 according to various embodiments 1400 analogous to embodiments 1300, in which the thermal marker 14 comprises a plurality of straight lines and/or strips extending away from the pick tip.

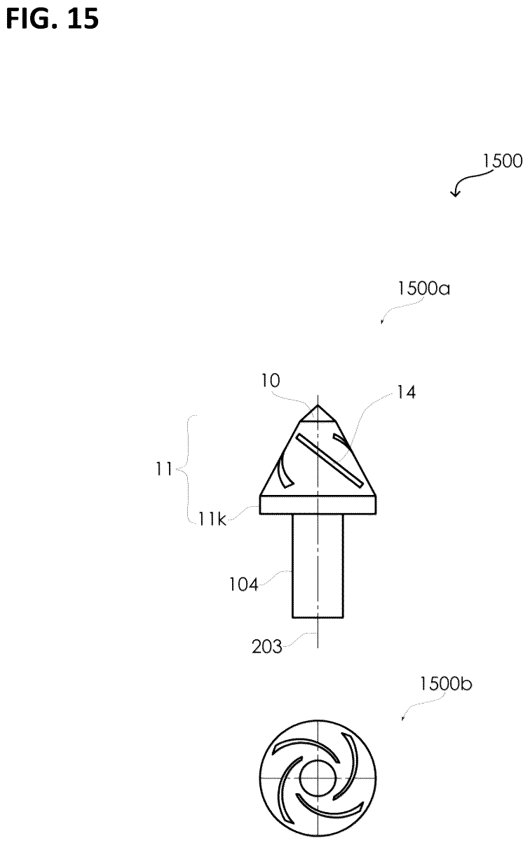

FIG. 15 illustrates a pick 5 in a schematic side view 1500a with viewing angle transverse to the pick axis 203 and a schematic top view 1500b with viewing angle along the pick axis 203 according to various embodiments 1500 analogous to embodiments 1300, 1400, in which the thermal marker 14 comprises a plurality of strips extending along a helical line.

FIG. 16 illustrates a pick 5 in a schematic side view 1600a with viewing angle transverse to the pick axis 203 and a schematic top view 1600b with viewing angle along the pick axis 203 according to various embodiments 1600 analogous to embodiments 1400, 1500, in which the thermal marker 14 comprises a coating 15 of the pick head 11 disposed between the pick tip 10 and the thickening 11k.

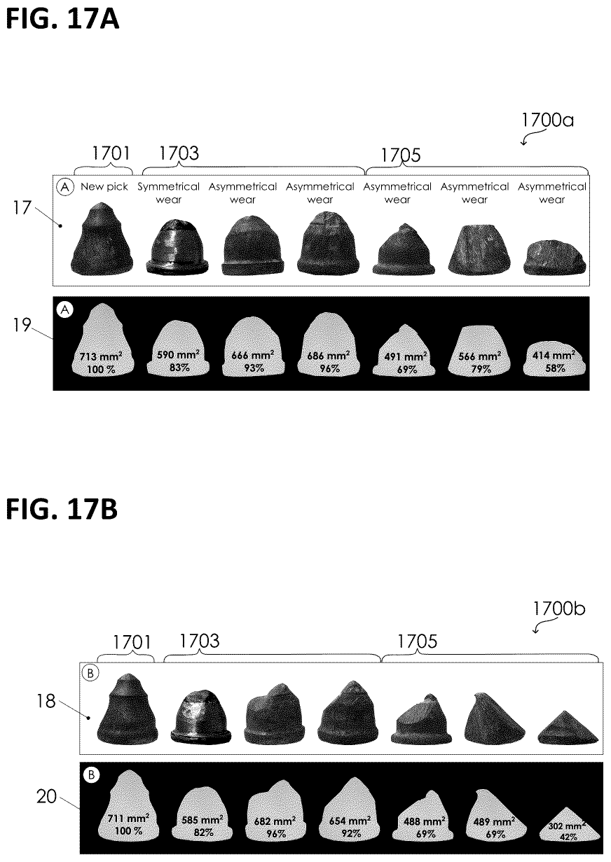

FIG. 17A illustrates picks 5 of different wear states in a schematic perspective view 17 and resulting geometrical representations in a schematic view 19 according to various embodiments, which are based on image data from a first perspective 1700a (for example perspective A in FIG. 12). FIG. 17B illustrates the same picks 5 in a schematic perspective view 18 and resulting geometrical representations in a schematic view 20 according to various embodiments based on image data from a second perspective 1700b (for example perspective B in FIG. 12).

Pick state 1701 represents an unused pick 5 (for example, as a target state) whose degree of wear is, for example, 0. Pick state 1703 represents a used pick 5 whose degree of wear is greater than 0, for example, and whose wear type (also referred to as wear type) is symmetrical wear. Pick state 1705 represents a used pick 5 whose degree of wear is greater than 0, for example, and whose wear type is asymmetrical wear. For the geometrical representation, the area is shown in view 19 as the first geometrical property and its ratio to the target pick state 1701 (in percent) as the second geometrical property.

Asymmetrical wear may comprise breaking off of parts of the pick tip 10 or grinding on one side due to a pick blockage taking place. As may be recognized, symmetrical wear may be difficult to distinguish from asymmetrical wear if image data is only available from one perspective. Asymmetrical wear, e. g. due to a pick blockage, may then be difficult to detect if the infrared camera 6 is in an unfavourable position.

According to various embodiments, the pick state may be based on a result of the geometrical comparison 811, which comprises a comparison of geometrical indication from different perspectives. This may facilitate distinguishing symmetrical wear from asymmetrical wear.

For example, asymmetrical wear may be determined as a pick state if a fluctuation of the geometrical property (e. g. the surface content and/or the contour) between the first perspective and the second perspective exceeds a threshold value.

In an exemplary implementation, view 19 shows geometrical representations of contours 13 of the pick 5 of different wear states, which are determined based on one or more infrared images 9 per pick 5. As may be recognized from the picks 5 shown above in perspective view 17, different wear states lead to similar indication on the area content or the ratio to the target pick state 1701. Nevertheless, an estimated remaining service life may be determined as the pick state based on the geometrical representation, for example its area content or its ratio to the target pick state 1701. The same pick states are shown in views 18 and 20 from a different perspective.

Alternatively, or additionally, the pick height of the pick head 11, the wedge angle of the pick 5, and/or the position of the centre of gravity of the determined pick contour 13 may be determined in order to determine the degree of wear, the remaining service life and/or the type of wear.

In an exemplary implementation, the actual state of one or more (e. g. each) picks 5 of the cutting head is updated after each rotational movement of the cutting head. For example, the actual pick state may be expressed as a value (also referred to as a state value) that is continuously updated. The state value may, for example, indicate how large the difference is between the actual pick state (e. g. the actual area content of the geometrical representation) and the target state of the respective pick 5.

If the variation of the geometrical indication between several perspectives exceeds a threshold value, the state determination may have to determine the asymmetrical wear type, and otherwise determine the symmetrical wear type, as a component of the pick state. Alternatively, or additionally, the state determination may comprise converting the fluctuation of the geometrical indication into a degree of asymmetry of the wear as a component of the pick state.

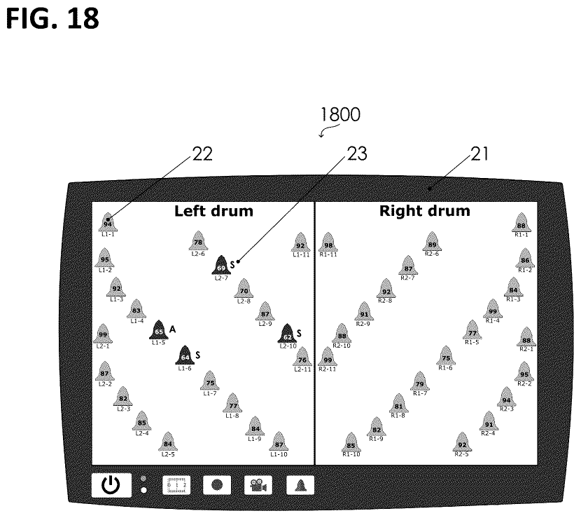

FIG. 18 illustrates a graphical user interface 21 of the excavation machine 202 in a schematic plan view 1800, in which the method 100 comprises the (e. g. updated) actual pick state of the or each pick (as a result of the state determination 103) graphically output, at least in the form of a graphical representation and/or as a state value. The updated actual pick state is thus made more visible to the operator of the excavation machine 202.

The graphical user interface may be implemented using the data processing device 106 and/or a display device (e. g., comprising a display and/or a touch screen). The graphical user interface may comprise both physical components and code-based components (e. g., software).

The graphical representation may, for example, indicate each pick 5 in its position on the cutting head 2 as a symbol 22 (e. g. pictogram), supplemented by the condition value, the wear type and/or a pick numbering. The pick numbering may, for example, comprise a code representing the position of the pick, e. g. L1-1 for the first pick 5 of the first spiral on the left cutting drum 2.

In an exemplary implementation, the graphical user interface is configured to display a symbol 22 (also referred to as a pick symbol) for each pick 5 in addition to the pick numbering, including the condition value and the wear type 23. In the display, the indication “S” corresponds to the symmetrical wear type and “A” to the asymmetrical wear type. If the area of the surface 13a falls below a threshold value, e. g. below 70% of the nominal area of the surface 13 a, the colour of the pick symbol is changed, for example to red, to indicate a high degree of wear as a component of the actual pick condition.

Alternatively or additionally, the graphical user interface may be configured to output the infrared images 9 in response to a user input, for example, which provides the user with an alternative basis for controlling the excavation machine 202.

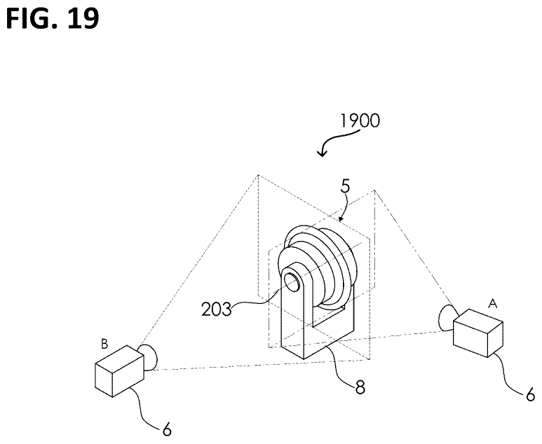

FIG. 19 illustrates a configuration of the camera system during image sensing 803 according to various embodiments in a schematic perspective view 1900, for example analogous to the image sensing 803 of the flow charts 1600, 1700 and/or 1800, similar to the perspective view 1200 with the difference that the pick 5 is a roller cutter of the disk cutter type. What is described herein for the disk cutter may apply by analogy to a roller cutter of the button cutter type. A roller cutter 5 is rotatably mounted around its cutter axis during operation, for example using a pivot bearing. The pivot bearing may, for example, be integrated into the roller cutter 5 or the cutter holder 8.

The camera system may comprise at least one infrared camera 6, e. g. two or more infrared cameras 6. Several infrared cameras 6 may be configured to sense the roller cutter 5 (e. g. at the same time) from different perspectives (also referred to as stereo view) (for example perspective A and perspective B). In this respect, what is described herein (see FIGS. 17A and 17B) applies by analogy.

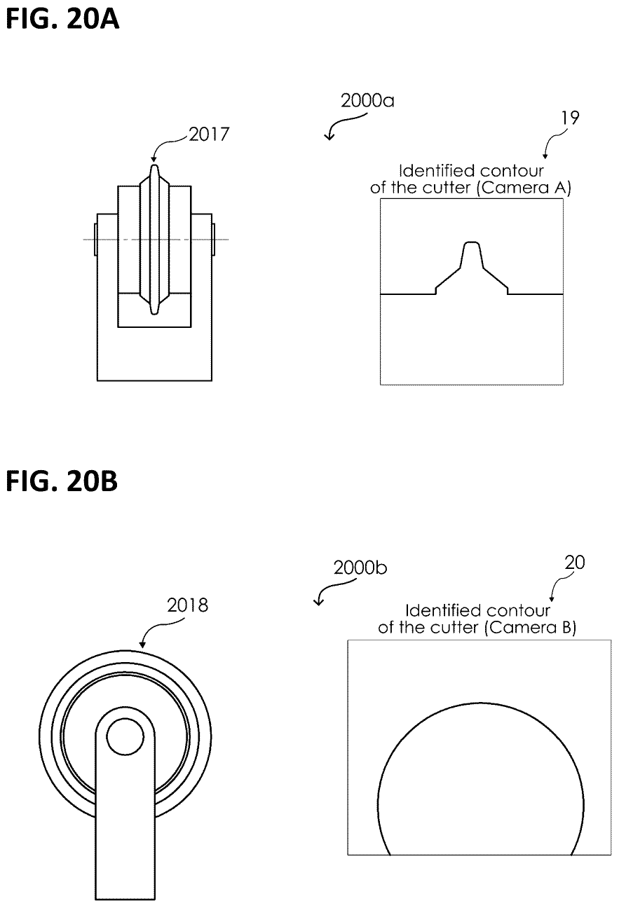

FIG. 20A illustrates roller cutter 5 in a schematic side view 2017 and a resulting geometrical representation in a schematic view 19 according to various embodiments, which are based on image data from a first perspective 2000a (for example perspective A in FIG. 19). FIG. 20B illustrates the same roller cutter 5 in a schematic side view 2018 and resulting geometrical representations in a schematic view 20 according to various embodiments, which are based on image data from a second perspective 2000b (for example perspective B in FIG. 19). In this respect, what is described herein (see, for example, FIGS. 17A and 17B) applies by analogy.

Various implementations of the camera system 502 are detailed below, which may be used individually or also to implement one or more of the aspects described herein, for example, the excavation system 200 and/or the method 100. The camera system 502 comprises one or more camera protection devices and, per camera protection device, at least one (i. e. one or more than one) infrared imaging camera. The camera protection device is configured to protect the at least one infrared camera, e. g. at least its camera lens, from liquid (e. g. water) and/or solid particles (e. g. dust, splinters and debris).

In a first exemplary implementation of the camera system 502, the or each camera protection device comprises a pressurized gas source for periodically cleaning (also referred to as blowing) and/or continuously displacing the solid particles from the at least one infrared camera, e. g., the lens thereof, using a gas stream. In a second exemplary implementation of the camera system 502, the or each camera protection device comprises a shutter in front of the lens that is opened (e. g., only) for the duration of the image sensing (e. g., for the aperture time or longer).

In the second or a third exemplary implementation of the camera system 502, the or each camera protection device comprises a housing in which the at least one infrared camera is disposed and which comprises an opening (also referred to as a housing opening) at which the infrared camera is directed. The housing opening may be covered using the shutter, which moves relative to the housing. Alternatively, or additionally, the housing may be disposed in a recess and moved out of the recess (e. g. folded out) for the duration of the image sensing (e. g. for the aperture time or longer) and then moved back in (e. g. folded in).

In the fourth exemplary implementation of the camera system 502, each camera protection device comprises a carrier (e. g. wall-shaped) that is transparent to infrared radiation (also referred to as a shield), at which the infrared camera is directed. The carrier may, for example, be disposed in a fixed position relative to the infrared camera or be movably mounted (and for example driven) relative to the infrared camera. Alternatively, or additionally, the carrier may be in the form of a hollow cylinder in which the infrared camera is disposed and/or which is rotated. Alternatively, or additionally, the carrier may be in the form of a disk and/or plate shape, which is, for example, rotated. The carrier may, for example, be made of ceramic, e. g. chalcogenide glass, or plastic. Alternatively, or in addition to the moving carrier, the gas flow may be directed at the carrier.

Various examples are described below that relate to the above description and the figures.

Example 1 is an excavation system comprising: an excavation machine (preferably configured as a crusher or cutting machine), which comprises a machine pick (herein simplified also referred to as a pick) or at least one pick holder for holding the machine pick (which is for example movably mounted), and is configured for excavating a material using the machine pick; at least one (i. e. one or more than one) infrared camera for sensing (e. g. infrared-based or at least temperature-based) image data representing the machine pick and/or the pick holder; a data processing device which is configured to: determine an indication representing the at least one geometrical property of the machine pick based on the image data; determine a state of the machine pick based on the indication; preferably output instructions indicating and/or based on the state of the machine pick.

Example 2 is a camera system with at least one infrared camera or the excavation system according to claim 1, which further comprises: a camera protection device which is configured to protect the at least one infrared camera from solid particles. This improves the service life of the infrared camera.

Example 3 is configured as in example 2, wherein the camera protection device comprises a pressurized gas source which is configured to direct a gas flow onto the camera or to flow around it using the gas flow. This is less complex and inexpensive to implement.

Example 4 is configured as in example 2 or 3, wherein the camera protection device comprises a shutter with a shutter flap, wherein a camera lens of the at least one infrared camera is disposed between the shutter flap and an infrared image sensor of the at least one infrared camera, and wherein the shutter is configured to open the shutter flap during sensing and to close it afterwards (e. g. otherwise). This protects the infrared camera better against fragments.

Example 5 is configured as in any of examples 2 to 4, wherein the camera protection device comprises a housing in which the at least one infrared camera is disposed, and which is configured to fold out the at least one infrared camera during sensing and to fold it in afterwards or otherwise. This protects the infrared camera better against fine dust.

Example 6 is configured as in any of examples 2 to 5, wherein the camera protection device comprises a transparent and/or wall-shaped carrier (e. g. at least for infrared radiation) through which the sensing takes place, wherein preferably a camera lens of the at least one infrared camera is disposed between the carrier and an infrared image sensor of the at least one infrared camera. This protects the infrared camera better against fine dust and fragments and is mechanically more reliable.

Example 7 is configured as in example 6, further comprising: a drive device which is configured to set the carrier in motion, e. g. in a rotary motion and/or relative to the infrared camera. This extends the service life of the carrier (e. g. until cleaning).

Example 8 is configured as in example 6 or 7, wherein the carrier: is plate-shaped and/or disk-shaped; (e. g. formed as a glass cylinder) surrounds a cavity in which the at least one infrared camera is disposed; is formed as a foil; and/or comprises or consists of plastic or glass. This is cost-effective.

Example 9 is a machine pick (e. g. the machine pick in any of examples 1 to 8), comprising: a cutting component (e. g. a pick head) comprising a cutting edge, preferably formed as a pick tip (e. g. provided using an embedded pick pin); a mounting component (illustrative for mounting the machine pick), preferably formed as a shaft (also referred to as a pick shaft) or a shaft extending, for example, away from the cutting edge (e. g. along or transverse to an axis, e. g. longitudinal axis or rotational axis, of the machine pick); and a marker which is embedded or cut into the cutting component or with which the cutting component is coated, wherein the cutting component and the marker differ from one another in at least one thermal property, preferably in a thermal emissivity and/or a thermal conductivity; wherein preferably the mounting component and the cutting component are rigidly connected to each other and/or wherein the marker is strip-shaped and/or ring-shaped or comprises at least several strip-shaped and/or ring-shaped marker segments; wherein preferably the mounting component is shaft-shaped, comprises an axle or comprises at least one through-opening for receiving an axle. This improves state detection.

Example 10 is a method (e. g., for operating an excavation system, camera system, or example 1 to 9), comprising: determination of an indication representing a geometrical property of a machine pick based on image data representing a machine pick and preferably a pick holder holding the machine pick; determination of a state of the machine pick based on the indication; preferably driving an excavation process performed using the machine pick based on a result of the determination of the state of the machine pick.

Example 11 is a computer program configured to perform the method according to claim 10. This facilitates the automation of the method.

Example 12 is a computer-readable medium that (e. g. using code segments) stores instructions, which is configured to, when executed by a processor, cause the processor to perform the method according to claim 10. This facilitates the automation of the method.

Example 13 is a data processing device (e. g. for a camera system or an excavation machine according to any one of claims 1 to 12) comprising one or more processors configured to perform the method according to claim 11. This facilitates the automation of the method.

Example 14 is an excavation system comprising: an excavation machine comprising a machine pick or at least one pick holder for holding the machine pick, and configured to excavate a material using the machine pick; at least one infrared camera for sensing image data representing the machine pick and/or the pick holder; and the data processing apparatus according to claim 13.

Example 15 is configured as one of examples 1 to 14, wherein the at least one infrared camera is attached to the excavation machine. This facilitates implementation.

Example 16 is configured as one of examples 1 to 15, further comprising: a stand carrying the at least one infrared camera, wherein the stand: comprises a handle to be carried by a user in operation; and/or comprises one or more feet to be disposed standing on a surface in operation. This increases flexibility.

Example 17 is configured as in any of examples 1 to 16, wherein the excavation machine comprises a (e. g. rotatably mounted) cutting head to which the machine pick is attached (e. g. form-fittingly). This increases the excavation rate.

Example 18 is configured as in any of examples 1 to 17, wherein the at least one infrared camera is configured to sense one or more (e. g. infrared-based) frames of the cutting head as image data for each revolution of the cutting head. This improves the data basis.

Example 19 is configured as in any of examples 1 to 18, wherein the cutting head is configured as a transverse cutting head or as a longitudinal cutting head, wherein the transverse cutting head is preferably drum-shaped (e. g. configured as a drum cutter). This increases the excavation rate.

Example 20 is configured as in any of examples 1 to 19, wherein the excavation machine comprises a pivot bearing using which the machine pick, e. g. its cutting head, is movably mounted (e. g. in rotation). This increases the excavation rate.

Example 21 is configured as in any of the examples 1 to 20, wherein the excavation machine comprises a power train (e. g. comprising the cutting head) which is configured to set the machine pick in a rotating movement. This increases the excavation rate.

Example 22 is configured as in any of the examples 1 to 21, wherein an image sensing frequency during operation of the at least one infrared camera is greater than a rotational speed of the rotational movement. This improves the data basis.

Example 23 is configured as in any of examples 1 to 22, wherein the at least one infrared camera comprises one or more camera lenses (e. g. forming a lens) and an infrared image sensor. This improves the data basis. For example, the camera lens may comprise or consist of infrared transmissive glass, e. g. one or more lenses thereof.

Example 24 is configured as in any of examples 1 to 23, wherein the data processing device and/or the instructions are configured to control the excavation machine based on a result of the determination of the state of the machine pick. This facilitates automation.

Example 25 is configured as in any of examples 1 to 24, wherein the determination of the indication comprises: determination of a data-based representation (e. g. contour) of a geometry of the machine pick, preferably from the viewpoint of the at least one infrared camera, based on the image data; wherein the indication comprises or is at least based on one or more properties of the data-based representation of the geometry. This facilitates state determination.

Example 26 is configured as in example 25, wherein the data-based representation of the geometry of the machine pick comprises one or more of the following: a data-based contour of the geometry of the machine pick; a data-based surface enclosed by the contour of the geometry of the machine pick; and/or a planar projection (from the camera's point of view) of the machine pick. This further facilitates state determination.

Example 27 is configured as in example 25 or 26, wherein the indication comprises or is at least based on one or more of the following (e. g. geometrical) properties of the data-based representation: a perimeter; a (e. g. geometrical) centre of gravity (preferably of the planar projection enclosed by a contour of the machine pick); an area; a shape; an angle enclosed by two edges of the data-based representation. This further facilitates state determination.

Example 28 is configured as in examples 25 to 27, wherein determination of the data-based representation comprises: determination of a plurality of image components (e. g. pixels or voxels) of the image data which fulfil a criterion; wherein the data-based representation is based on the plurality of image components; wherein the criterion preferably comprises a criterion of a filter (e. g. an edge detection) and/or comprises a homogeneity criterion and/or a gradient criterion. This further facilitates state determination.

Example 29 is configured as in example 28, wherein the determination of the data-based representation comprises: converting the plurality of image components into a closed path (e. g. a polyhedron), wherein the data-based representation comprises, consists of or is at least based on the path; wherein the converting is preferably performed using smoothing. This further facilitates state determination.

Example 30 is configured as in any of examples 1 to 29, wherein the at least one geometrical property represents (e. g. comprises) one or more of the following properties: a shape of the machine pick and/or a symmetry of the shape; an extension (e. g. length) of the machine pick; and/or a wedge angle of the machine pick. This further facilitates state determination.

Example 31 is configured as in any of examples 1 to 30, wherein the indication comprises a plurality of components, each component being associated with a geometrical property, wherein the determination of the state comprises weighting the plurality of components. This facilitates adapting the state determination to variable conditions.

Example 32 is configured as in any of examples 1 to 31, wherein the state of the machine pick represents a wear of the machine pick, preferably one or more characteristics (e. g. symmetry and/or progress) of the wear of the machine pick. This facilitates a preventive reaction and thus reduces operating costs.

Example 33 is configured as in any of examples 1 to 32, wherein the image data comprises a plurality of frames, each frame representing the machine pick, wherein the determination of the indication is based on the plurality of frames. This improves the data basis.

Example 34 is configured as in example 33, wherein the indication comprises a plurality of components, of which a first component is based on a first frame of the plurality of frames, and a second component is based on a second frame of the plurality of frames, wherein the determination of the state is preferably based on a comparison of the first component and the second component with each other. This reduces the resources for data processing.

Example 35 is configured as in example 33 or 34, wherein the image data is combined to form a panoramic image on the basis of which the determination of the indication takes place. This reduces the resources required for data processing.

Example 36 is configured as in any of examples 1 to 35, wherein the determination of the state comprises selecting one of several predefined (e. g. stored) states. This reduces the resources for data processing.

Example 37 is configured as in example 36, wherein the plurality of predefined states comprises one or more of the following states: Machine pick is missing; machine pick is in need of maintenance (e. g., when the remaining service life of the machine pick is greater than zero); machine pick is in need of replacement (i. e., remaining service life of the machine pick is zero); and/or remaining service life of the machine pick is greater than zero. This reduces the resources for data processing.

Example 38 is configured as in any of examples 1 to 37, further comprising: outputting instructions indicating or based on the state of the machine pick. This facilitates a preventive reaction and thus reduces operating costs.

Example 39 is configured as in example 38, wherein the instructions at least comprise instructions for the operation of the pick and/or are configured to control an excavation process that is carried out using the machine pick. This facilitates a preventive reaction and thus further reduces operating costs.

Example 40 is configured as in any of examples 1 to 39, wherein the machine pick comprises a marker (e. g. providing a pattern), which is preferably embedded, cut into or with which the pick head is coated (wherein for example the pick head and the marker differ from each other in at least one thermal property, preferably in a thermal emissivity and/or a thermal conductivity), which preferably forms a scale, wherein the determination of the indication is based on the marker (wherein the indication comprises for example an indication about a geometrical property of the marker). This facilitates state determination.

Example 41 is configured as in example 40, wherein the machine pick comprises a coating and/or materials of different thermal conductivity or grooves, using which the marker is formed. This further facilitates the state determination.

Example 42 is configured as in any of examples 1 to 41, further comprising: driving the at least one infrared camera based on data from a sensor (e. g. rotation angle sensor) which is configured to sense a movement of the machine pick. This facilitates a preventive reaction and thus further reduces operating costs.

Example 43 is configured as in any of examples 1 to 42, wherein the at least one infrared camera comprises several infrared cameras. This improves the data basis.

Example 44 is configured as in any of examples 1 to 43, wherein the image data comprises a stereoscopic image pair (e. g. representing the machine pick) and/or stereoscopic image data formed therefrom, wherein the state (e. g. a state value thereof) of the pick is preferably based on a difference between frames of the image pair. This improves the data basis.

Example 45 is configured as in any of examples 1 to 44, wherein the image data comprises or consists of stereoscopic image data. This improves the data basis.

Example 46 is configured as in any of the examples 1 to 45, wherein the image data representing a machine pick comprises thermographic information of the machine pick. This improves the data basis in the case of dust and water mist.

Example 47 is configured as in any of examples 1 to 46, wherein the condition of the machine pick is a wear condition of the machine pick, e. g. representing a degree of wear and/or a wear symmetry of the machine pick. This facilitates a preventive reaction and thus further reduces operating costs.

Example 48 is configured as in any of examples 1 to 47, wherein the image data is infrared-based image data. This improves the data basis in the case of dust and water mist.

Example 49 is configured as in any of examples 1 to 48, wherein the infrared camera is configured to sense the image data based on infrared radiation (e. g. at least emitted by the machine pick). This improves the data basis in the case of dust and water mist.

Example 50 is configured as in any of examples 1 to 49, wherein the image data comprises a (e. g. data-based and/or pixel-based) representation of a spatial temperature distribution (e. g. starting at least from the machine pick). This improves the data basis in the case of dust and water mist.

Example 51 is configured as in any of examples 1 to 50, wherein the state of the machine pick is determined as the actual state of the machine pick.

Example 52 is configured as in any of examples 1 to 51, wherein the machine pick is mounted movably along a movement path, wherein the infrared camera is directed at the movement path.

Example 53 is configured as in any of examples 1 to 52, wherein the at least one infrared camera comprises a plurality of infrared cameras whose fields of view (e. g. on the path of movement of the pick holder and/or the machine pick) overlap each other or comprise a distance from each other.

Example 54 is configured as in any of examples 1 to 53, wherein the at least one infrared camera is directed at a movement path of the pick holder and/or the machine pick.

Example 55 is configured as in any of examples 1 to 54, wherein the geometrical property is invariant with respect to or at least independent of an (e. g. average) emissivity of the machine pick. This allows the geometrical property to be determined without needing to determine the temperature.

Example 56 is configured as in any of examples 1 to 55, wherein the geometrical property is invariant to or at least independent of a calibration of the infrared camera. This allows that the temperature does not have to be determined in order to determine the geometrical property.

Example 57 is configured as in any of examples 1 to 56, wherein the image data is based on infrared radiation (also referred to as infrared radiation based) emitted, for example, at least from the machine pick (optionally from the pick holder and/or the environment of the machine pick) and/or sensed using the at least one infrared camera.

Example 58 is configured as in any of examples 1 to 57, wherein the thermal property is a property which influences the infrared radiation.

Example 59 is configured as in any of examples 1 to 58, wherein the emissivity is an emissivity for infrared radiation (also referred to as thermal emissivity).

Example 60 is configured as in any of examples 1 to 59, wherein the image data comprises or consists of at least infrared image data (also referred to as thermographic image data).

Example 61 is configured as in any of examples 1 to 60, wherein the image data is sensed using a process of thermography.

Various exemplary implementations are explained below, which relate to the aspects described here, such as the data processing chain from image data to classification.

An exemplary implementation of the determination of the geometrical indication representing the at least one geometrical property of the pick is performed using one or more first algorithms, examples of which comprise: an image processing algorithm, a contrast enhancement algorithm, a feature detection algorithm, a segmentation algorithm, e. g. thresholding algorithm. One or more of these exemplary algorithms may be provided, for example, using a library, examples of which comprise: OpenCV, Scikit-Image, SciPy, NumPy, and other libraries. For example, the temperature-based image data may be converted into a black and white image using a threshold transformation as an exemplary image processing algorithm. Optionally, the temperature-based image data may be transformed using a Gaussian blur filter to remove (e. g. small-scale) image noise and/or using an erosion algorithm to sharpen it, e. g. to sharpen a blurred image. Optionally, the black and white image may be converted into a contour image, for example using the Sobel edge detection algorithm.

An exemplary implementation of the determination of the geometrical representation is carried out using an image processing algorithm, examples of which comprise: an edge detection, a Fourier high-pass filter, a threshold filter, a Fourier low-pass filter, a colour value difference analysis, an object detection, a geometry detection, a trained algorithm.

Examples of an edge detection algorithm comprise: Sobel edge detection, Canny edge detection. An exemplary library that provides a colour value difference analysis is the so-called colormath library. Examples of an algorithm for object recognition comprise: YOLO (“You Only Look Once”, refers to a class of end-to-end deep learning models for fast object recognition), RCNN (a region-based convolutional neural network), Faster-RCNN, for example provided using libraries such as OpenCV or TensorFlow. Examples of an algorithm for geometry recognition comprise: the Hough transform (in OpenCV).

An exemplary implementation of object recognition using the YOLO algorithm comprises a first step in which a section of a temperature-based image is identified that shows a pick head with a certain, high degree of certainty. A second step identifies edges or prominent points in this area.

An exemplary implementation of the determination of the geometrical indication, which represents the at least one geometrical property of the pick, may be implemented as follows:
Converting the image data into a blurred image using a transformation (also known as transforming);
Converting the blurred image into a black and white image using a filter (also known as filtering);
Converting the black and white image into a contour image using an edge detection algorithm (also known as edge detection);
Determination of one or more boundary points of smooth contour lines and, based thereon, determination of a contour model (e. g. a vector image as an exemplary contour model, which is also referred to as a vector model);
Determination of the area content of closed contours in the contour image (e. g. based on the vector model), e. g. using an algorithm configured for this purpose;
Determination of characteristic geometrical parameters as geometrical indication (examples comprise: the height of the pick head, the opening angle of the pick head tip, etc.) of closed contours in the contour image (e. g. from the vector model), e. g. based on the coordinates of the outermost points of the contours;

Optional determination of further contour features as geometrical indication (e. g. contour moment, centre of gravity and circumference of one or more contours), e. g. by using an algorithm configured for this purpose, e. g. using known mathematical operations.

An exemplary implementation of the determination of the pick state based on the geometrical indication is performed using one or more second algorithms, examples of which comprise: a reference comparison algorithm, a statistical algorithm, for example provided from a library, examples of which comprise: numPy, Pandas. For example, the geometrical indication may be converted into a pick wear state using a shape matching algorithm (e. g. matchShapes from OpenCV library) as a comparison algorithm. Optionally, the geometrical indication may be transformed using a projection correction to compensate for the influence of the viewing angle, which may be used alternatively or additionally to select a suitable reference model.

An exemplary implementation of the shape comparison algorithm comprises that the surface area of the detected pick head is compared with the surface area of a detected pick head of the same pick in new condition (as a reference).

An exemplary implementation of the determination of the pick state based on the geometrical indication may be implemented as follows:
Comparison of the geometrical indication with a reference, for example using matchShape as an exemplary shape comparison algorithm;
Determination of one or more differences between the geometrical indication (e. g., a pick head height or other geometrical property of the pick) and the reference based on comparing the geometrical indication with the reference (e. g., one or more geometrical indication thereof);
Comparison of the one or more differences with a criterion, which may be, for example, a threshold value for a deviation of the pick head height (or other geometrical property of the pick);
Classification of the geometrical indication based on the comparison of one or more differences with the criterion;

Examples of the reference comprise: a geometrical indication of a reference pick determined in a similar way as explained above; a model of a reference pick; a statistical model of a reference pick.

An exemplary implementation of the output of instructions indicating and/or based on the state of the machine pick is carried out using generation of a message according to a communication protocol. The message may, for example, comprise an indication of the state of the machine pick, such as a result of the classification. The message may, for example, comprise a warning and/or instruction to change the machine pick. The message may, for example, comprise a symbol that is output on the display device (e. g. a display) that visually shows the pick wear state using colours. The message may, for example, be addressed to a graphics driver that controls the display device and/or to the machine operator and/or to the machine control system (e. g. containing instructions such as “STOP advance”). Examples of the communication protocol comprise: TCP/IP, UDP, eBus, USB, ProfiBus, CANopen (communication protocol based on a Controller Area Network (CAN) bus).

As explained above, it may be understood that the embodiments explained herein are applicable to excavation machines of various types, such as cutting machines (for example rock cutting machines), in particular those in which rotating cutting drums with conical picks are mounted. Examples of such an excavating machine comprise so-called roadheaders, continuous miners, shearer loaders, horizontal cutters, surface miners, tunnelling machines and drum cutters, which are generally used to excavate material (e. g. a grown or otherwise massive and extensive rock body) associated with the ground (e. g. to loosen it from layers of the ground, e. g. rock layers), in order for example to advance into the ground (also referred to as tunnelling). Other examples of such an excavating machine also comprise so-called crushers (e. g. drum or roller crushers, cone crushers, or configured in the form of another crushing machine), which are used to crush lumpy (or other loose) material (e. g. chunks or other material loosened from the ground). In other words, the term “excavation” may generally be understood to mean a breaking up (e. g. crushing) of solid material (e. g. lumps or layers of the ground, e. g. rock layers), e. g. a crushing (e. g. into a plurality of smaller bodies) of the material so that bulk material is formed or at least the grain size is reduced. By analogy, such a crusher (e. g. rock crusher) may comprise a drum with one or more picks mounted thereon (e. g. in a respective holder), exemplarily one or more conical picks mounted in a respective pick holder, which is used, for example, in connection with the exemplary infrared camera and the data processing system.

1. An excavation system comprising:
an excavation machine comprising a rotatable cutting head and, attached thereto, at least one machine pick or pick holder for holding the machine pick, and is configured to excavate a material using the machine pick;
at least one infrared camera for sensing image data representing the machine pick or the pick holder;
a data processing device configured to:
determine an indication representing at least one geometrical property of the machine pick based on the image data; and
determine a state of the machine pick based on the indication.

2. The excavation system according to claim 1, wherein the at least one infrared camera is directed at a self-closed movement path of the pick holder and/or the machine pick.

3. The excavation system according to claim 1, wherein the rotatable cutting head provides a circular movement path of the pick holder, the machine pick comprises a revolution carrier chain to which the pick holder is attached and/or picks attached thereto, or both.

4. The excavation system according to claim 1, wherein the at least one infrared camera is configured to sense a plurality of frames of the rotatable cutting head as image data per revolution of the rotatable cutting head.

5. The excavation system according to claim 1, wherein the state of the machine pick represents a wear of the machine pick.

6. The excavation system according to claim 1, wherein the image data is stereoscopic image data.

7. The excavation system according to claim 1, further comprising:
a camera protection device configured to protect the at least one infrared camera from solid particles; wherein the camera protection device comprises a carrier, which is transparent for infrared radiation and through which the image data is sensed.

8. The excavation system according to claim 1, wherein the determination of the indication comprises:
the determination of a data-based representation of a geometry of the machine pick, based on the image data;
wherein the indication comprises or is at least based on one or more properties of the data-based representation;
wherein the state is determined based on a comparison of the indication with a reference state of the machine pick provided by another indication previously determined for the machine pick.

9. The excavation system according to claim 1, wherein the indication comprises or is at least based on one or more of the following geometrical properties of the data-based representation:
a perimeter;
a center of gravity;
an area;
a shape;
an angle, which is enclosed by two edges of the data-based representation; or
combinations thereof.

10. (canceled)

11. A method comprising:
determining an indication representing a geometrical property of a machine pick based on temperature-based image data representing the machine pick, wherein the machine pick is attached to a rotatable cutting head or held by a pick holder attached to the rotatable cutting head; and
determining a state of the machine pick based on the indication.

12. A non-transitory computer medium storing instructions that, when executed by one or more processors, causes the one or more processors to perform the method according to claim 11.

13. (canceled)

14. A data processing device comprising the one or more processors according to claim 12.

15. (canceled)

16. The excavation system according to claim 1, wherein sensing the image data is synchronized with a movement of the machine pick.

17. The excavation system according to claim 7, further comprising a pressurized gas source configured to clean the camera using a gas flow.

18. The excavation system according to claim 7, wherein the carrier comprises plastic, which is transparent for infrared radiation and through which the image data is sensed.

19. The excavation system according to claim 7, wherein the camera further comprises a camera lens, and wherein the carrier is plate-shaped.

20. The excavation system according to claim 7, wherein the carrier comprises ceramic, which is transparent for infrared radiation and through which the image data is sensed.

21. The excavation system according to claim 1, wherein the cutting head is rotatable relative to the camera.

22. A monitoring system comprising:
at least one infrared camera for sensing image data representing a machine pick attached to a rotatable cutting head or held by a pick holder attached to the rotatable cutting head; and
a data processing device configured to:
determine an indication representing at least one geometrical property of the machine pick based on the image data; and
determine a state of the machine pick based on the indication.
